(19) United States
(12) Patent Application Publication
(10) Pub. No.: US 2025/0227395 A1
(43) Pub. Date: Jul. 10, 2025

(54) ADJUSTABLE COMMUNICATION EQUIPMENT ASSEMBLY STRUCTURE AND APPARATUS COMPRISING SAME

(71) Applicant: Samsung Electronics Co., Ltd., Suwon-si (KR)

(72) Inventors: Donghwan KIM, Suwon-si (KR); Kucheol AHN, Suwon-si (KR); Hyungjun KOO, Suwon-si (KR); Jihee KWAK, Suwon-si (KR); Youngjin KIM, Suwon-si (KR)

(21) Appl. No.: 19/092,544

(22) Filed: Mar. 27, 2025

Related U.S. Application Data
(63) Continuation of application No. PCT/KR2023/013464, filed on Sep. 7, 2023.

(30) Foreign Application Priority Data
Sep. 28, 2022 (KR) 10-2022-0123815

(51) Int. Cl. H04Q 1/02

(52) U.S. Cl. CPC H04Q 1/02

(57) ABSTRACT

An assembly is provided. The assembly includes a first bracket, a second bracket, and a third bracket which is engaged with the first bracket and the second bracket and, between the first bracket and the second bracket. The third bracket includes a first portion including at least one first fasten member. The third bracket includes a second portion including a first slit, arranged with respect to the at least one first fasten member and disposed along a first direction, and at least one sleeve. The second portion is moved with respect to the first portion. The third bracket includes a third portion, rotatably connected to the second portion based on a rotation axis, including a second slit formed as a curve, engaged with the second bracket, and arranged with respect to the at least one sleeve. The third portion is rotated with respect to the first portion and the second portion.

CROSS-REFERENCE TO RELATED APPLICATION(S)

This application is a continuation application, claiming priority under 35 U.S.C. § 365 (c), of an International application No. PCT/KR2023/013464, filed on Sep. 7, 2023, which is based on and claims the benefit of a Korean patent application number 10-2022-0123815, filed on Sep. 28, 2022, in the Korean Intellectual Property Office, the disclosure of which is incorporated by reference herein in its entirety.

### BACKGROUND

### 1. Field

The disclosure relates to an assembly structure capable of adjusting a position of communication equipment and an electronic device including the same.

### 2. Description of Related Art

In a communication system, communication equipment (e.g., a radio unit (RU), an access unit (AU) including the RU and a digital unit (DU), and a small cell, and the like) may be installed in various installation environments, and may be arranged in consideration of the installation environment for smooth communication. At this time, an assembly structure for connecting the communication equipment to a support structure in the installation environment such as a wall, a ceiling, or a pole may include a function for adjusting a position of the communication equipment. In adjusting a direction or the position of the communication equipment, there may be a restriction according to an environment in which the communication equipment is installed. The assembly structure may adjust the position of the communication equipment while minimizing an influence of the restriction of the surrounding environment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an assembly structure capable of adjusting a position of communication equipment and an electronic device including the same.

Additional aspects will be set forth in part in the description which follows and, in part, will be apparent from the description, or may be learned by practice of the presented embodiments.

In accordance with an aspect of the disclosure, an assembly is provided. The assembly includes a first bracket coupled to a support structure in an installation environment. The assembly includes a second bracket configured to couple to communication equipment. The assembly includes a third bracket, engaged with the first bracket and the second bracket between the first bracket and the second bracket, for changing an orientation of the second bracket and changing a position of the second bracket. The third bracket includes a first portion, engaged with the first bracket, including at least one first fasten member. The third bracket includes a second portion including a first slit, arranged with respect to the at least one fasten member and disposed along a first direction, and at least one sleeve. The second portion moves with respect to the first portion in accordance with the at least one first fasten member moved toward the first direction in the first slit or the at least one first fasten member moved toward a second direction opposite to the first direction in the first slit. The third bracket includes a third portion, rotatably connected to the second portion based on a rotation axis, including a second slit, formed as a curve, engaged with the second bracket, and arranged with respect to the at least one sleeve. The third portion rotates with respect to the first portion and the second portion in accordance with the at least one sleeve moved toward a first rotation direction in the second slit or the at least one sleeve moved toward a second rotation direction opposite to the first rotation direction in the second slit.

In accordance with another aspect of the disclosure, a base station is provided. The base station includes communication equipment. The base station includes a support structure. The base station includes an assembly disposed between the support structure and the communication equipment. The assembly includes a first bracket coupled to the support structure. The assembly includes a second bracket coupled to the communication equipment. The assembly includes a third bracket, engaged with the first bracket and the second bracket between the first bracket and the second bracket, for changing an orientation of the second bracket and changing a position of the second bracket. The third bracket includes a first portion, engaged with the first bracket, including at least one first fasten member. The third bracket includes a second portion including a first slit, arranged with respect to the at least one fasten member and disposed toward a first direction, and at least one sleeve. The second portion moves with respect to the first portion in accordance with the at least one first fasten member moved toward the first direction in the first slit or the at least one first fasten member moved toward a second direction opposite to the first direction in the first slit. The third bracket includes a third portion, rotatably connected to the second portion based on a rotation axis, including a second slit formed as a curve, engaged with the second bracket, and arranged with respect to the at least one sleeve. The third portion rotates with respect to the first portion and the second portion in accordance with the at least one sleeve moved toward a first rotation direction in the second slit or the at least one sleeve moved toward a second rotation direction opposite to the first rotation direction in the second slit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2A illustrates an example of a fixed-type assembly structure for describing a device according to an embodiment of the disclosure;

FIG. 2B illustrates another example of a fixed-type assembly structure for describing a device according to an embodiment of the disclosure;

FIG. 3 illustrates an example of a tilting assembly structure for describing a device according to an embodiment of the disclosure;

FIG. 4 illustrates another example of a tilting assembly structure for describing a device according to an embodiment of the disclosure;

FIG. 5 illustrates an example of an assembly structure for a television (TV) for describing a device according to an embodiment of the disclosure;

FIGS. 6A and 6B illustrate examples of an assembly structure according to various embodiments of the disclosure;

FIG. 7 is an exploded perspective view with respect to an example of an assembly structure according to an embodiment of the disclosure;

FIG. 8 is a six-sided view with respect to an example of an assembly structure according to an embodiment of the disclosure;

FIG. 9 is another exploded perspective view with respect to an example of an assembly structure according to an embodiment of the disclosure;

FIG. 10 illustrates an example of a sliding operation of an assembly structure according to an embodiment of the disclosure;

FIG. 11 illustrates an example with respect to a rotating (or tilting) operation of an assembly structure according to an embodiment of the disclosure;

FIG. 12A illustrates an example with respect to a coupling state between an assembly structure and a support structure in an installation environment according to an embodiment of the disclosure;

FIG. 12B illustrates another example of a coupling state between an assembly structure and a support structure in an installation environment according to an embodiment of the disclosure;

FIG. 13 illustrates another example of an assembly structure according to an embodiment of the disclosure;

FIG. 14A is an exploded perspective view with respect to another example of an assembly structure according to an embodiment of the disclosure;

FIG. 14B is a six-sided view with respect to another example of an assembly structure according to an embodiment of the disclosure;

FIG. 15 illustrates an example of a sliding operation and a rotating (or tilting) operation of an assembly structure according to an embodiment of the disclosure;

FIG. 16 illustrates another example of an assembly structure according to an embodiment of the disclosure;

FIG. 17A is an exploded perspective view with respect to another example of an assembly structure according to an embodiment of the disclosure;

FIG. 17B is a six-sided view with respect to another example of an assembly structure according to an embodiment of the disclosure; and

FIG. 18 illustrates an example of a sliding operation and a rotating (or tilting) operation of an assembly structure according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include

plural referents unless the context clearly dictates otherwise. Thus, for example, reference to “a component surface” includes reference to one or more of such surfaces.

Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

A term referring to a part of a device (e.g., an assembly, an assembling structure, a bracket, a bolt, a nut, a sleeve, a sleeve block, a member, a module, an antenna, an antenna element, circuitry, a processor, a chip, a component, and a device), a term referring to a shape of a part (e.g., a slit, a structure body, a structure, a support portion, a protrusion, and an opening), a term referring to a connection between components (e.g., a connection portion, a contact portion, and a feeding unit), a joint of components, and the like, that are used in the following description, are exemplified only for convenience of description. Therefore, the disclosure is not limited to terms to be described below, and another term having an equivalent technical meaning may be used. In addition, a term such as ‘ . . . unit,’ . . . device, ‘ . . . object’, and ‘ . . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

In a communication system, communication equipment (e.g., a radio unit (RU), an access unit (AU) including the RU and a digital unit (DU), and a small cell, and the like) may be disposed at a specific location in consideration of a surrounding environment in order to perform smooth communication. That is, the communication equipment needs to be disposed in consideration of a support structure in various installation environments (e.g., a wall, a ceiling, a pole, a tower, and the like). In order for the communication equipment to be coupled into various support structures in installation environments in this way, an assembly structure (e.g., a bracket or assembly of brackets) that connects or couples each other may be required. However, if a fixed-type assembly structure is used when coupling the communication equipment and a support structure in the installation environment by using the assembly structure, a specific separation distance may always be required, and producing the fixed-type assembly structure with various separation distances to solve this problem may cause complexity in the manufacturing process. In addition, even in a case of an assembly structure including a rotation function (hereinafter, rotation may be referred to as tilting), a separation distance between the communication equipment and the support structure in the installation environment may be required to perform tilting, and a problem that increases a size of the assembly structure may be generated. In other words, in order to overcome limitation according to various installation environments, an assembly structure capable of increasing communication performance while utilizing a minimum amount of space may be required.

Hereinafter, the disclosure proposes, in an assembly structure connecting communication equipment and an installation environment, a structure in which a portion connected to the communication equipment and a portion connected to the support structure in the installation environment are slidable and rotatable (hereinafter referred to as an assembly capable of adjusting a position of the communication equipment).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

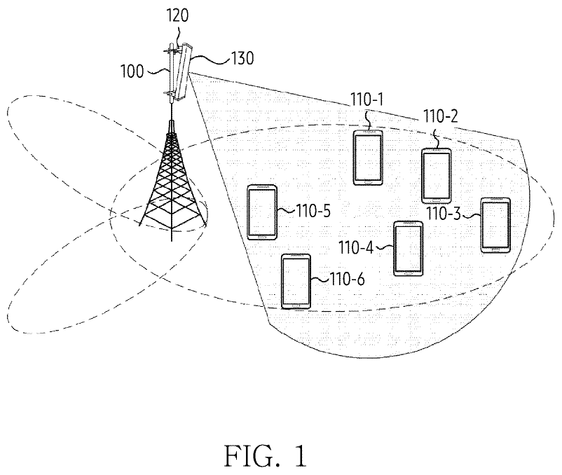

FIG. 1 illustrates a wireless communication system according to an embodiment of the disclosure.

The wireless communication environment of FIG. 1 exemplifies a base station 100 and terminals 110-1 to 110-6 as a portion of nodes using a wireless channel.

Referring to FIG. 1, the base station 100 is a network infrastructure that provides wireless access to the terminals 110-1 to 110-6. The base station 100 has coverage defined as a certain geographical area based on a distance capable of transmitting a signal. The base station 100 may be referred to as, in addition to the base station, an ‘access point (AP)’, an ‘eNodeB (eNB)’, a ‘5th generation (5G) node’, a ‘5G NodeB (NB)’, a ‘wireless point’, a ‘transmission/reception point (TRP)’, an ‘access unit’, a ‘distributed unit (DU)’, a ‘transmission/reception point (TRP)’, a ‘radio unit (RU), a remote radio head (RRH)’, or another term having an equivalent technical meaning to these. The base station 100 may transmit a downlink signal or receive an uplink signal.

The terminals 110-1 to 110-6, which are devices used by a user, perform communication with the base station 100 through a wireless channel. In some cases, the terminals 110-1 to 110-6 may be operated without involvement of the user. That is, the terminals 110-1 to 110-6 are devices that perform machine type communication (MTC) and may not be carried by the user. The terminals 110-1 to 110-6 may be referred to as other than the term terminal, such as ‘user equipment (UE),’ a ‘mobile station,’ a ‘subscriber station,’ ‘customer premises equipment (CPE),’ a ‘remote terminal,’ a ‘wireless terminal,’ an ‘electronic device,’ or a ‘vehicle terminal,’ a ‘user device,’ or another term having an equivalent technical meaning to these.

According to an embodiment, the base station 100 may be coupled with communication equipment 130 by an assembly structure 120. The assembly structure 120 of FIG. 1 may be an assembly structure capable of adjusting the position of the communication equipment according to embodiments of the disclosure. In a situation where the base station 100 may require tilting for smooth communication with the terminals 110-1 to 110-6, a specific separation distance may be required to minimize interference between the communication equipment 130 and a support structure in an installation environment (e.g., the pole of the base station 100) due to the tilting. At this time, the communication equipment 130 may be fixed in a slid and tilted state by the assembly structure 120 according to the embodiments of the disclosure, and the interference may be minimized. Accordingly, the smooth communication may be performed between the base station 100 and the terminals 110-1 to 110-6.

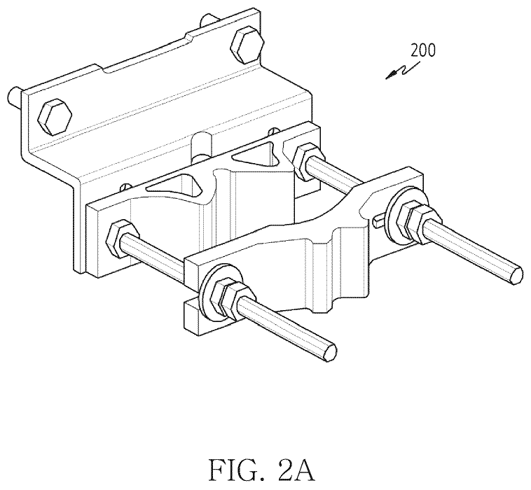

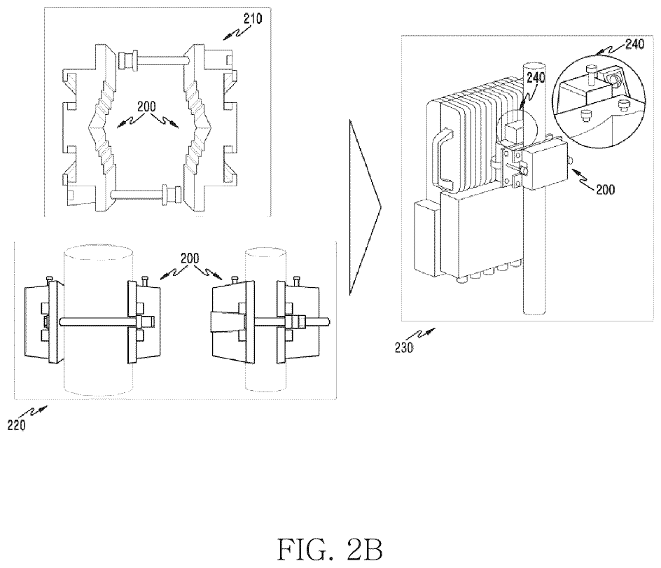

FIG. 2A illustrates an example of a fixed-type assembly structure for describing a device according to an embodiment of the disclosure. FIG. 2B illustrates another example of a fixed-type assembly structure for describing a device according to an embodiment of the disclosure.

Referring to FIG. 2A, a fixed-type assembly structure 200 is illustrated. In a case of the fixed-type assembly structure 200, it may include a first coupling member for coupling with a support structure in an installation environment and a second coupling member for coupling with communication equipment. In addition, in the case of the fixed-type assembly structure 200, a size of the first coupling member and the second coupling member may be fixed. The communication equipment coupled to the second coupling member of the fixed-type assembly structure 200 may be spaced apart from various support structures of installation environments by an equal distance, and the communication equipment may be connected in the same state.

Referring to FIG. 2B, installation processes 210, 220, 230, and 240 of the fixed-type assembly structure 200 are illustrated. Referring to the installation process 210, two fixed-type assembly structures 200 may be connected in pairs. For example, a portion of the first fixed-type assembly structure 200 may be coupled to a portion of the second fixed-type assembly structure 200 in an engaged shape. Referring to the installation process 220, the fixed-type assembly structure 200 may be coupled to a support structure in an installation environment (e.g., a pole) having different thicknesses. For example, considering a left drawing of the installation process 220, the fixed-type assembly structure 200 may be connected to a relatively thick pole. Referring to a right drawing of the installation process 220, the fixed-type assembly structure 200 may be connected to a pole having a relatively thinner thickness than the pole in the left drawing. Accordingly, the connection state of the first coupling member of the fixed-type assembly structure 200 may be different. In addition, referring to the installation process 230, the fixed-type assembly structure 200 may be coupled to the pole through the first coupling member and may be connected to the communication equipment through the second coupling member. Referring to the installation process 240, the fixed-type assembly structure 200 may be fixed to the communication equipment by a fasten member (e.g., a screw nail, a bolt, a nut, and the like) in the second coupling member. In this way, in the coupling between the support structure in the installation environment and the communication equipment by the fixed assembly structure 200, a separation distance may be fixed.

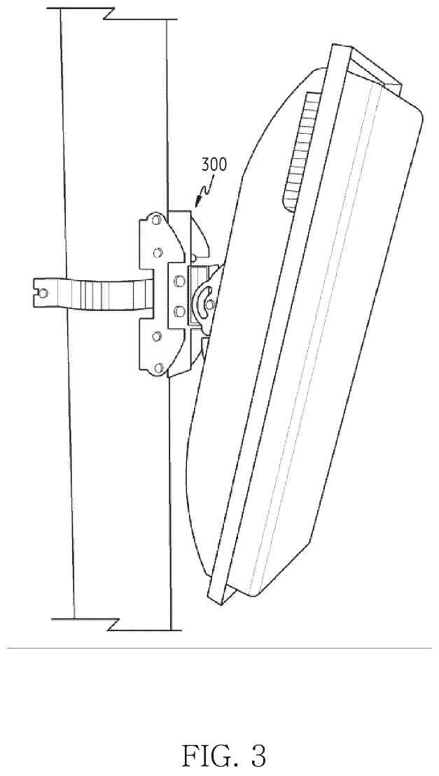

FIG. 3 illustrates an example of a tilting assembly structure for describing a device according to an embodiment of the disclosure.

Herein, tilting may mean that communication equipment is tilted or rotated with respect to a rotation axis.

Referring to FIG. 3, an assembly structure 300 capable of the tilting is illustrated. The assembly structure 300 may be coupled with a support structure in an installation environment (e.g., a pole) and the communication equipment. In addition, an inclination of the communication equipment may be adjusted by adjusting an inclination of a coupling member to which the assembly structure 300 is coupled to the communication equipment. However, in order to avoid interference between the tilted communication equipment and the surrounding installation environment, the assembly structure 300 may require a large separation distance from the support structure in the installation environment (e.g., a wall, a ceiling, and a pole) that does not include a tilting function. Herein, the separation distance may be determined based on the maximum tilting angle.

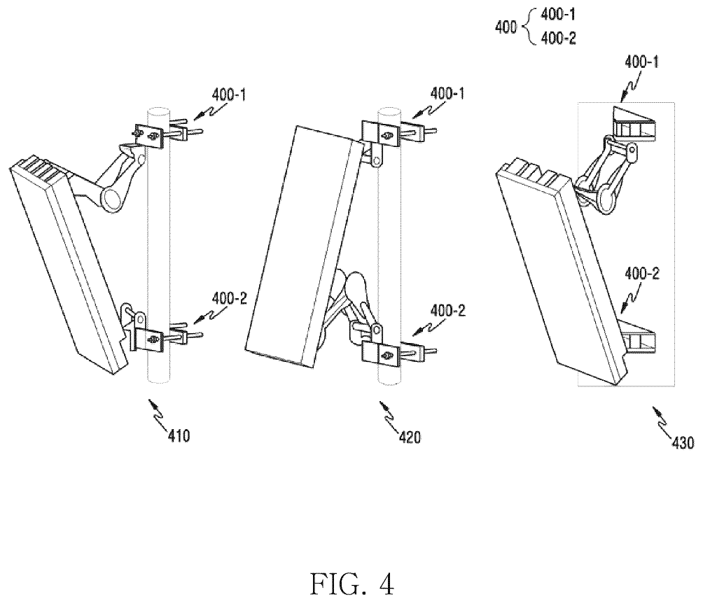

FIG. 4 illustrates another example of a tilting assembly structure for describing a device according to an embodiment of the disclosure.

Referring to FIG. 4, a first drawing 410 indicating a case in which an assembly structure 400, including a first assembly structure 400-1 and a second assembly structure 400-2, down-tilted by being coupled to a pole and communication equipment, is illustrated. In addition, FIG. 4 illustrates a second drawing 420 indicating a case in which the assembly structure 400, including the first assembly structure 400-1 and the second assembly structure 400-2, is up-tilted by being coupled to the pole and the communication equipment. In addition, FIG. 4 illustrates a third drawing 430 indicating a case in which the assembly structure 400, including the first assembly structure 400-1 and the second assembly structure 400-2, is down-tilted by being coupled to the wall and the communication equipment. The assembly structure 400 capable of the tilting may include at least two or more coupling members and a connection member of a joint structure. For example, the assembly structure 400 may include a first coupling member and a second coupling member for being coupled to the pole. The assembly structure 400 may be tilted according to a degree to which the connection member of the joint structure is folded.

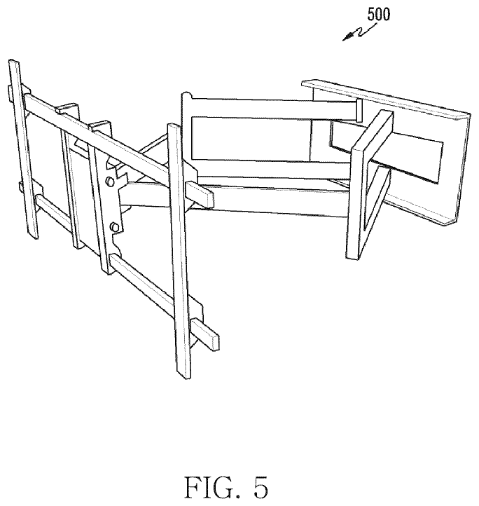

FIG. 5 illustrates an example of an assembly structure for a television (TV) for describing a device according to an embodiment of the disclosure.

An assembly structure 500 for the TV is illustrated. The assembly structure 500 for the TV may be formed as a segmented-type assembly structure for connecting a support structure in an installation environment such as a wall and the TV, and adjusting a separation distance between the a support structure in the installation environment and the TV.

Referring to FIGS. 2A, 2B, and 3 to 5, in the fixed-type assembly structure, a separation distance is fixed from a manufactured time point. In addition, in a case of an assembly structure capable of tilting, a separation distance may be determined based on the maximum tilting angle. That is, as a distance from a tilted rotating axis to communication equipment farther, it may space away from the support structure in the installation environment (e.g., a wall or a pole). When the tilting angle of the assembly structure that may be required in the actual installation environment is smaller than the maximum angle capable of the tilting, an unnecessary protruding area may be formed. Such the unnecessary protruding area may hinder efficient installation in installing the communication equipment. In the case of the assembly structure 300 of FIG. 3, the separation distance may be set in consideration of the maximum tilting angle, and the separation distance may be fixed. In addition, in the case of the assembly structure 400 of FIG. 4, at least two assembly structures may be required to perform a coupling function and a tilting function with the communication equipment, and by performing the tilting function, a portion of the assembly structures may protrude by a predetermined distance even when being folded. In addition, in the case of the assembly structure 500 for the TV of FIG. 5, the separation distance between the communication equipment and the support structure in the installation environment may be adjusted, but it may not be suitable for outdoor installation environments for installing the communication equipment installed at a base station.

In contrast, an assembly structure capable of adjusting a location of the communication equipment according to various embodiments of the disclosure may be applied in various installation environmental conditions as the separation distance can be adjusted, and may adjust the separation distance according to the tilting angle that may be required. In addition, even when the tilting function is performed, since the separation distance can be adjusted through one assembly structure (or assembly), it is more efficient than the existing assembly structure in terms of space utilization. Additionally, when coupled with the communication equipment, the assembly structure according to embodiments of the disclosure may be flexibly coupled through the one assembly structure despite the separation distance and the tilting angle that may require a change according to various environments. In addition, the assembly structure according to embodiments of the disclosure may maintain the same level of the minimum volume state as an assembly structure that does not include a tilting function during packaging and transportation. Therefore, the assembly structure according to the embodiments of the disclosure is more efficient and may minimize cost compared to the existing assembly structure in a manufacturing and transportation process.

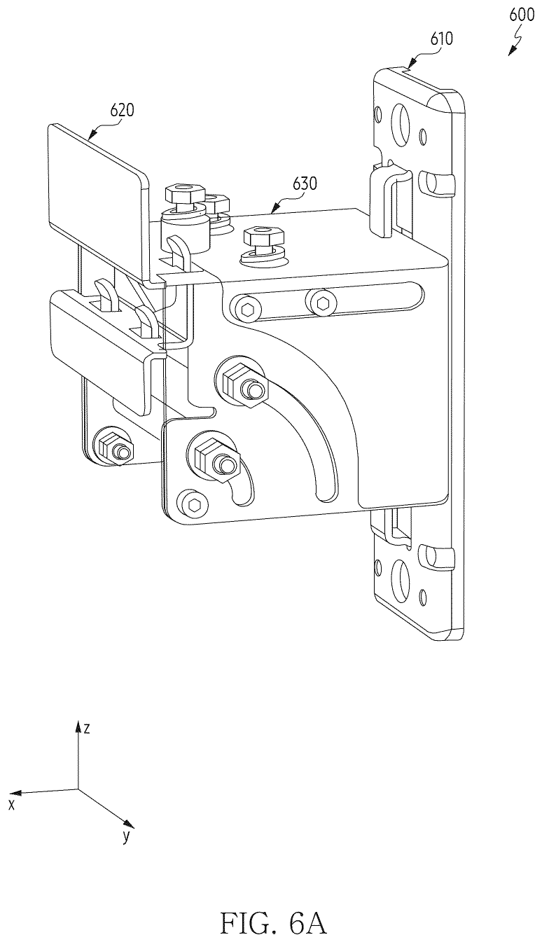

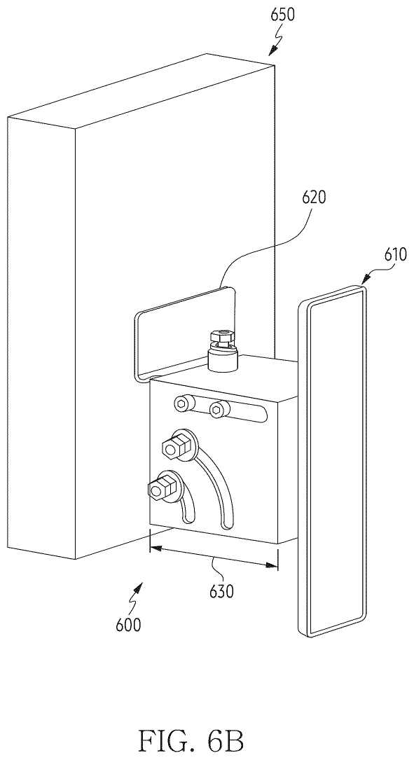

FIGS. 6A and 6B illustrate examples of assembly structures according to various embodiments of the disclosure. FIG. 6A is a perspective view of an assembly structure 600 viewed in a y-axis direction.

Referring to FIG. 6A, the assembly structure 600 may include a first bracket 610, a second bracket 620, and a third bracket 630. Herein, a bracket refers to a device for fixing or coupling a specific object and another object and may be defined as a meaning including a meaning equivalent to or similar thereto. For example, the bracket may be referred to as a coupling member. In addition, the assembly structure 600 may be understood as one bracket in which brackets are gathered. In other words, the assembly structure 600 may be referred to as an assembly, a bracket assembly, an assembly for coupling, and the like.

Referring to FIG. 6B, the assembly structure 600 may be positioned or disposed between communication equipment 650 and a support structure in an installation environment (not shown) and may be engaged with the communication equipment 650 and the support structure in the installation environment, respectively. The first bracket 610 may be a structure for connecting the assembly structure 600 to the support structure in the installation environment (e.g., a pole, a ceiling, a wall, a tower, and the like). For example, the first bracket 610 may be engaged with the support structure in the installation environment through a surface facing a direction opposite to the third bracket 630. The first bracket 610 may be engaged with the support structure in the installation environment through a fasten member (e.g., a screw nail, a bolt and a nut, a screw, and the like). In addition, the first bracket 610 may be engaged with the third bracket 630 through the fasten member (e.g., the screw nail, the bolt and the nut, the screw, and the like). In addition, the first bracket 610 may be integrally formed without being separated from the third bracket 630.

According to an embodiment, the second bracket 620 may be a structure for engaging the assembly structure 600 and the communication equipment 650. For example, the first bracket 610 may be engaged with the support structure in the installation environment through a surface facing the direction opposite to the third bracket 630. The second bracket 620 may be coupled to the communication equipment 650 through the fasten member (e.g., the screw nail, the bolt and the nut, the screw, and the like). In addition, the second bracket 620 may be engaged with the third bracket 630 through the fasten member.

According to an embodiment, the third bracket 630 may connect the first bracket 610 and the second bracket 620 between the first bracket 610 and the second bracket 620. The third bracket 630 may include a structure for adjusting the distance between the first bracket 610 and the second bracket 620. For example, the third bracket 630 may include a slit and a fasten member extending in an x-axis direction. In addition, the third bracket 630 may include a structure for changing a position (e.g., a direction, or an orientation) of the communication equipment 650 engaged with the second bracket 620 and the second bracket 620. For example, the third bracket 630 may include at least one curved shape slit with respect to a rotation axis of an area where a periphery adjacent to the second bracket 620 and another periphery extending from the periphery are in contact. The assembly structure 600 of FIGS. 6A and 6B includes two curved shape slits. However, the disclosure is not limited thereto, and the assembly structure 600 may include one curved shape slit or three or more curved shape slits. As the number of curved shape slits increases, stability of the assembly structure 600 may be secured when the second bracket 620 and the communication equipment 650 are rotated.

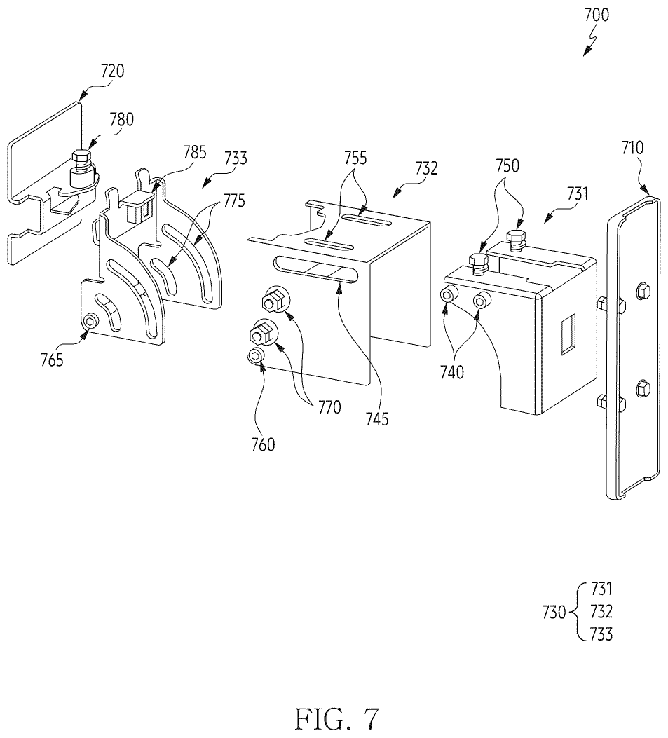

FIG. 7 is an exploded perspective view of an example of an assembly structure according to an embodiment of the disclosure.

An assembly structure 700 of FIG. 7 is an exploded view of the assembly structure 600 of FIGS. 6A and 6B, and may be understood in the same manner as the assembly structure 600 of FIGS. 6A and 6B.

Referring to FIG. 7, the assembly structure 700 may include a first bracket 710, a second bracket 720, and a third bracket 730. Herein, a bracket refers to a device for fixing or coupling a specific object and another object and may be defined as a meaning including a meaning equivalent to or similar thereto. For example, the bracket may be referred to as a coupling member. In addition, the assembly structure 700 may be understood as one bracket in which the brackets are gathered. In other words, the assembly structure 700 may be referred to as an assembly, a bracket assembly, an assembly for coupling, and the like.

The assembly structure 700 may be positioned or disposed between communication equipment (not shown) and a support structure in an installation environment (not shown), and may be engaged with the communication equipment and the support structure in the installation environment, respectively. The first bracket 710 may be a structure for connecting the assembly structure 700 to the support structure in the installation environment (e.g., a pole, a ceiling, a wall, a spire, and the like). For example, the first bracket 710 may be engaged with the support structure in the installation environment through a surface facing a direction opposite to the third bracket 730. The first bracket 710 may be engaged with the support structure in the installation environment through the fasten member (e.g., the screw nail, the bolt and the nut, the screw, and the like). Furthermore, the first bracket 710 may be engaged with the third bracket 730 through the fasten member (e.g., the screw nail, the bolt and the nut, the screw, and the like). Furthermore, the first bracket 710 may be integrally formed without being separated from the third bracket 730.

The second bracket 720 may be a structure for engaging the communication equipment with the assembly structure 700. For example, the second bracket 720 may be engaged with the support structure in the installation environment through a surface facing a direction opposite to the third bracket 730. The second bracket 720 may be coupled to the communication equipment through the fasten member (e.g., the screw nail, the bolt and the nut, the screw, and the like). Furthermore, the second bracket 720 may be engaged with the third bracket 730 through a coupling structure 785 coupled to a fasten member 780 and a fasten member 780. For example, the fasten member 780 and the coupling structure 785 may be composed of bolts and nuts.

The third bracket 730 may include a first portion 731, a second portion 732, and a third portion 733. The first portion 731 may couple the first bracket 710 and the third bracket 730. The first portion 731 may be engaged with the first bracket 710 through the fasten member. The first portion 731 may include a structure for a sliding operation of the third bracket 730. For example, the first portion 731 may include a first fasten member 740 for moving along a first slit 745 of the second portion 732. Herein, the first fasten member 740 may be formed in various structures. For example, the first fasten member 740 may include a plurality of pairs of bolts and nuts. In addition, the first fasten member 740 may be formed of one linear type of metal. The first portion 731 may include a second fasten member 750 for fixing the second portion 732 after the sliding operation of the third bracket 730. The second fasten member 750 may be engaged by penetrating a hole in the first portion 731 and a coupling structure 755 of the second portion 732. The hole in the first portion 731 and the coupling structure 755 of the second portion 732 may be configured differently according to a shape of the second fasten member 750.

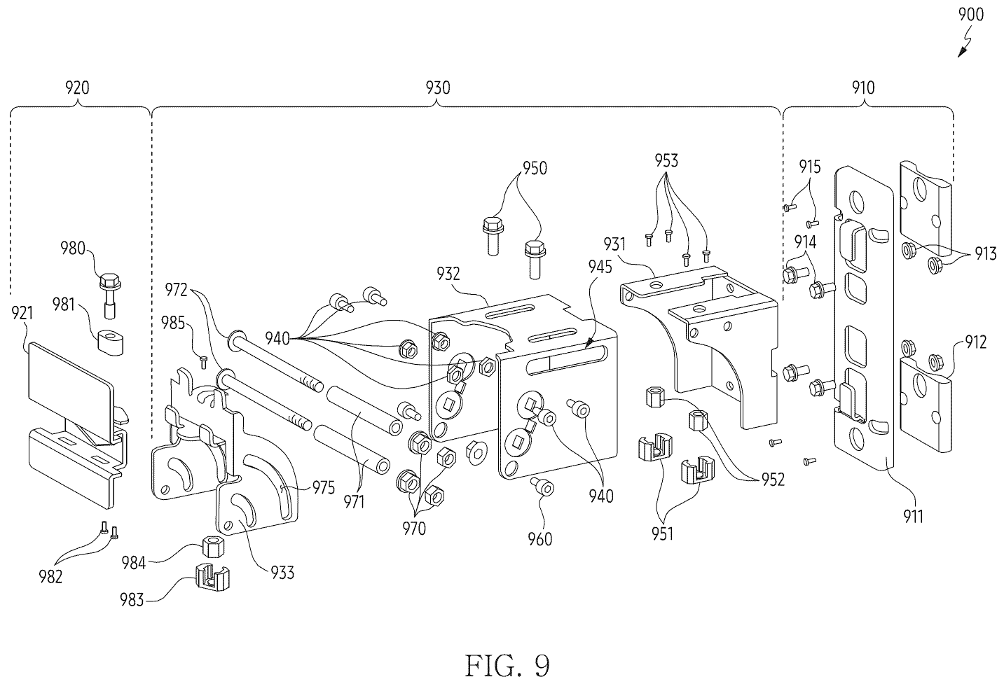

The second portion 732 may include the first slit 745 for the sliding operation of the third bracket 730. The first slit 745 may be formed in a structure for guiding the first fasten member 740 of the first portion 731. For example, the first fasten member 740 may be engaged so as to move along the first slit 745. Accordingly, a separation distance between the second portion 732 and the first bracket 710 may be adjusted. In addition, the second portion 732 may include a third fasten member 760 for engaging the third portion 733 through a coupling structure 765. A virtual line penetrating the center of the third fasten member 760 may be a rotation axis that is the center of an operation of rotating the second bracket 720. The second portion 732 may include a sleeve 770 connected to the second slit 775 in a curved shape of the third portion 733. Although not specifically illustrated in FIG. 7, as described in FIG. 9 below, the sleeve 770 may include a nut for engaging, a sleeve block, and a bolt for engaging and extending along the sleeve block. The third portion 733 may be rotated through the sleeve 770 disposed to be movable along the second slit 775 within the second slit 775. The second bracket 720 and the communication equipment may be rotated through the movement of the second slit 775 and the sleeve 770 of the third portion 733.

The third bracket 730 may include a structure for changing a position (e.g., a direction, or an orientation) of the communication equipment engaged with the second bracket 720 and the second bracket 720. For example, the third bracket 730 may include at least one curved second slit 775 with respect to a rotation axis of an area in which a periphery adjacent to the second bracket 720 and another periphery extending from the periphery are in contact. The assembly structure 700 of FIG. 7 includes two curved slits. However, the disclosure is not limited thereto, and the assembly structure 700 may include one curved shape or three or more curved slits. As the number of curved slits increases, stability of the assembly structure 700 may be secured when the second bracket 720 and the communication equipment are rotated. The third portion 733 may include a coupling structure 765 to be coupled to the second portion 732. Also, the third portion 733 may include a coupling structure 785 to be coupled to the second bracket 720.

As described above, the assembly structure 700 may include the first bracket 710 for connecting with the support structure in the installation environment, the second bracket 720 for engaging the communication equipment, and the third bracket 730 between the first bracket 710 and the second bracket 720. The third bracket 730 may be configured as a structure for performing the sliding operation and the rotating operation of the assembly structure 700. Accordingly, the assembly structure 700 may connect the communication equipment to the support structure in the installation environment even when a space for installation is narrow. The communication equipment coupled through the assembly structure 700 may be spaced apart from the support structure in the installation environment by a predetermined distance, and interference in which a signal transmitted and received by the communication equipment receive from the support structure in the installation environment may be minimized. In addition, the communication equipment installed by being rotated by a predetermined angle through the assembly structure 700 may efficiently transmit and receive the signal to and from another external device. In other words, the communication equipment connected to the support structure in the installation environment through the assembly structure 700 may improve communication performance.

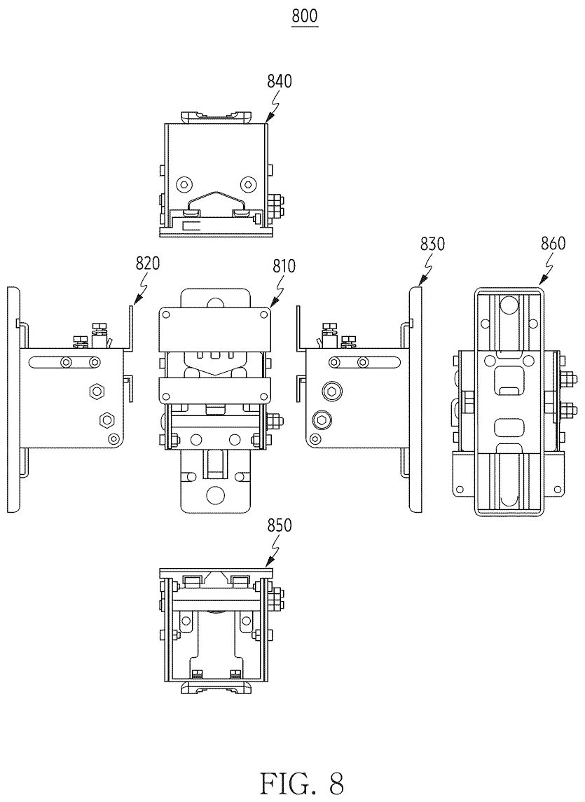

FIG. 8 is a six-sided view with respect to an example of an assembly structure according to an embodiment of the disclosure.

An assembly structure 800 of FIG. 8 may be understood in the same manner as the assembly structure 600 of FIGS. 6A and 6B and the assembly structure 700 of FIG. 7. For convenience of description, FIG. 8 illustrates an example in which an assembly structure 800 is not moved or rotated (or tilted).

Referring to FIG. 8, a front view 810, a left-side view 820, a right-side view 830, an upper side view 840, a lower side view 850, and a rear view 860 of the assembly structure 800 are illustrated. Referring to the front view 810, a surface of the second bracket of the assembly structure 800 may include a plurality of coupling structures (e.g., a hole or a slit) engaged with communication equipment. In addition, although FIG. 8 illustrates that the second bracket of the assembly structure 800 is engaged with the communication equipment through two contact surfaces, the disclosure is not limited thereto, and the second bracket may be engaged with the communication equipment through one contact surface. In other words, the structure of the second bracket may be changed based on a type of communication equipment engaged with the second bracket, a size of the communication equipment, a method of coupling the communication equipment, and the like.

Referring to the left-side view 820 and the right-side view 830, the assembly structure 800 may be configured to be symmetrical to each other with respect to a virtual surface passing through the center of the assembly structure 800. However, since a sleeve for sliding of the assembly structure 800 includes a bolt and a nut penetrating the assembly structure 800, the assembly structure 800 may be configured as a structure penetrating from left to right or from right to left. That is, a position of the nut or bolt included in the sleeve of the assembly structure 800 may be reversed.

Referring to the upper side view 840, the assembly structure 800 may include two second fasten members penetrating the first portion and the second portion of the third bracket, and a coupling structure for connecting the second bracket and the third bracket.

Referring to the lower side view 850, the assembly structure 800 may include a sleeve extending from a left side to a right side, and the sleeve may include a sleeve block extending from the left side to the right side of the assembly structure 800. The assembly structure 800 of FIG. 8 may include two sleeves.

Referring to the rear view 860, the assembly structure 800 may include a first bracket for connection with the support structure in the installation environment. In FIG. 8, the first bracket of the assembly structure 800 is configured to have the longest shape compared to another portion of the assembly structure 800, but this is merely an example for description. In other words, the first bracket of the assembly structure 800 may be configured to have a surface shape having a length similar to that of the third bracket. However, when the first bracket is formed to be long at the upper end and the lower end, the first bracket may be more stably engaged with the support structure in the installation environment compared to when the first bracket is formed to be short.

FIG. 9 is another exploded perspective view with respect to an example of an assembly structure according to an embodiment of the disclosure.

Herein, a bracket refers to a device for fixing or coupling a specific object with another object and may be defined as a meaning including a meaning equivalent or similar thereto. For example, the bracket may be referred to as a coupling member. Also, an assembly structure 900 may be understood as one bracket in which the brackets are gathered. In other words, the assembly structure 900 may be referred to as an assembly, a bracket assembly, an assembly for coupling, and the like. The assembly structure 900 of FIG. 9 may be understood in the same manner as the assembly structure 600 of FIGS. 6A and 6B.

Referring to FIG. 9, the assembly structure 900 may include a first bracket 910, a second bracket 920, and a third bracket 930. The assembly structure 900 may be positioned or disposed between communication equipment (not shown) and a support structure in an installation environment (not shown) and may be engaged with the communication equipment and the support structure in the installation environment, respectively. The first bracket 910 may be a structure for connecting the assembly structure 900 to the support structure in the installation environment (e.g., a pole, a ceiling, a wall, a spire, and the like).

According to an embodiment, the first bracket 910 may include a base bracket 911 and a support bracket 912. The base bracket 911, which is a portion connected to the third bracket 930, may refer to a main bracket of the first bracket 910. The first bracket 910 may include the support bracket 912 capable of increasing engaging force while minimizing a space between the base bracket 911 and the support structure in the installation environment. The support bracket 912 may be configured as a pair including an upper bracket and a lower bracket. The first bracket 910 may include fasten members 913 and 914 for engaging a first portion 931 of the third bracket 930 and the base bracket 911. In addition, the first bracket 910 may include a fasten member 915 for connecting the base bracket 911 and the support bracket 912. For example, the fasten members 913 and 914 may include bolts and nuts. For example, the fasten member 915 may include a screw nail or a screw. However, the disclosure is not limited thereto, and the fasten members 913 and 914 may include a screw nail, a screw, and the like, capable of engaging and fixing a plurality of configurations. In addition, the fasten member 915 may include a bolt and a nut.

According to an embodiment, the second bracket 920 may include a unit bracket 921, which is a main bracket for engaging with communication equipment (e.g., a radio unit (RU), an access unit (AU) including the RU and a digital unit (DU), a small cell, and the like). In order to be engaged with the communication equipment in contact with the main bracket 921, the main bracket 921 may be configured as a structure having an upper surface and a lower surface spaced apart from each other. However, the disclosure is not limited thereto, and the main bracket 921 may be changed according to a type of communication equipment coupled to the second bracket 920, a size of the communication equipment, a method of coupling to the communication equipment, and the like. The second bracket 920 may include fasten members 980 and 984 to be directly engaged with the third bracket 930. For example, the fasten members 980 and 984 may include a bolt and a nut. However, the disclosure is not limited thereto, and the fasten members 980 and 984 may include a screw nail, a screw, and the like, capable of engaging and fixing a plurality of configurations. In addition, the assembly structure 900 may further include a sleeve block 981 for the fasten members 980 and 984, a fasten member 982 for engaging the sleeve block 981 to the unit bracket 921, a holder 983 for engaging the fasten member 984 to the third portion 933, and a fasten member 985 for fastening the holder 983 to the third portion 933. The sleeve block 981, the fasten member 982, the holder 983, and the fasten member 985 may be configured to increase engaging force of the fasten members 980 and 984, and to minimize abrasion of the second bracket 920 and the third bracket 930 due to fastening. Therefore, when an engaging method of the second bracket 920 and the third bracket 930 gets different, the sleeve block 981, the fasten member 982, the holder 983, and the fasten member 985 may be omitted.

According to an embodiment, the third bracket 930 may include the first portion 931, a second portion 932, and the third portion 933. The first portion 931 may have a structure that connects the first bracket 910 and the third bracket 930. The first portion 931 may be engaged with the base bracket 911 through the fasten members 914 and 915. The first portion 931 may include a structure for a sliding operation of the third bracket 930. For example, the first portion 931 may include a first fasten member 940 for moving along a first slit 945 of the second portion 932. The first fasten member 940 may be engaged to the first portion 931, and, may be disposed to be positioned in an area corresponding to the first slit 945 when the first portion 931 and the second portion 932 overlap. Herein, the first fasten member 940 may be formed in various structures. For example, the first fasten member 940 may include a plurality of pairs of bolts and nuts. In addition, the first fasten member 940 may be composed of one linear type of metal.

The assembly structure 900 may include second fasten members 950 and 952 for fixing the second portion 932 after the sliding operation of the third bracket 930. The second fasten members 950 and 952 may be engaged by penetrating a hole of the first portion 931 and a coupling structure of the second portion 932. In FIG. 9, the hole of the first portion 931 is shown in a circular shape, and the coupling structure of the second portion 932 is shown in a slip-shape, however the disclosure is not limited thereto. The hole of the first portion 931 and the coupling structure of the second portion 932 may be configured differently according to shapes of the second fasten members 950 and 952. The assembly structure 900 may further include a holder 951 for coupling of the second fasten members 950 and 952, and a fasten member 953 for engaging the holder 951 to the first portion 931. The holder 951 and the fasten member 953 may be configured to increase engaging force of the second fasten members 950 and 952 and to minimize abrasion of the first portion 931 and the second portion 932 due to the engaging. Therefore, when an engaging method of the first portion 931 and the second portion 932 gets different, the holder 951 and the fasten member 953 may be omitted.

The assembly structure 900 may include a third fasten member 960 for coupling the second portion 932 and the third portion 933. For example, the third fasten member 960 may include a bolt and a nut. However, the disclosure is not limited thereto, and the fasten member 960 may include a screw nail, a screw, and the like, capable of engaging and fixing a plurality of configurations. A virtual line penetrating the center of the third fasten member 960 may be a rotation axis of the rotational motion of the third portion 933.

According to an embodiment, the third portion 933 may include a structure for changing a position (e.g., a direction, or an orientation) of the second bracket 920 and the communication equipment engaged with the second bracket 920. For example, the third portion 933 may include at least one curved second slit 975 with respect to a rotation axis of an area in which a periphery adjacent to the second bracket 920 and another periphery extending from the periphery are in contact. The rotation axis may be a virtual line penetrating the center of the third fasten member 960. The assembly structure 900 of FIG. 9 includes two curved second slits 975. However, the disclosure is not limited thereto, and the assembly structure 900 may include one curved shape or three or more curved slits. As the number of curved slits increases, stability of the assembly structure 900 may be secured during rotation of the second bracket 920 and the communication equipment.

The assembly structure 900 may include the third portion 933, the second bracket 920, and sleeves 970 to 972 for rotation motion of the communication equipment. The sleeves 970 to 972 may be engaged to the second portion 932 and, may be disposed to be positioned in an area corresponding to the second slit 975 when the third portion 933 and the second portion 932 overlap. The sleeves 970 to 972 may include a nut 970 for engaging, a sleeve block 971, and a bolt 972 extending along the sleeve block 971 for engaging. The third portion 933 may be rotated through the sleeves 970 to 972 disposed to be movable along the second slit 975 within the second slit 975.

Referring to the above description, the assembly structure 900 may adjust a distance between the communication equipment and the support structure in the installation environment and may change the orientation (or the position) of the communication equipment through a plurality of portions 931, 932, and 933 included in the third bracket 930 that is one structure of the assembly structure 900. Specifically, the assembly structure 900 may adjust the distance between the communication equipment and the support structure in the installation environment through a sliding operation of the first portion 931 and the second portion 932. For example, the distance between the communication equipment and the support structure in the installation environment may be determined based on interference received by the support structure in the installation environment by a signal transmitted and received from the communication equipment. In addition, the assembly structure 900 may change the orientation of the communication equipment through rotation (or tilting) of the second portion 932 and the third portion 933. Through the rotation operation (or tilting), a range of the orientation of the communication equipment may be determined by a rotation angle centered on the rotation axis. Herein, the rotation angle may be determined according to a curved opening of the second slit 975. The curved opening of the second slit 975 may be designed to be determined according to coverage of the communication equipment. Assuming that the communication equipment is spaced apart from the ground in a vertical direction, and a transmission/reception unit of the communication equipment is installed in a horizontal direction to the ground. For example, when the coverage of the communication equipment is 45°, users present in the vertical direction of the communication equipment may find it difficult to receive a service through the communication equipment. In such an installation environment, it may be necessary to rotate the communication equipment by a certain angle in a direction of the ground. The rotation angle may be required by the minimum of 45°. For example, an angle at which the communication equipment may be maximally rotated along the second slit 975 may be 70°, and in this case, the distance between the communication equipment and the support structure in the installation environment may be 150 mm.

The assembly structure 900 capable of adjusting the position of the communication equipment of the disclosure may adjust the position of the communication equipment while minimizing space utilization through a more simplified structure. The assembly structure 900 capable of adjusting the position of the communication equipment of the disclosure may implement both a sliding operation and a rotating operation through one configuration. Accordingly, the engaging force between the communication equipment and the support structure in the installation environment may be increased by minimizing a load applied to the slid and/or rotated assembly structure 900, and there is an effect in that the stability of the assembly structure 900 may be secured.

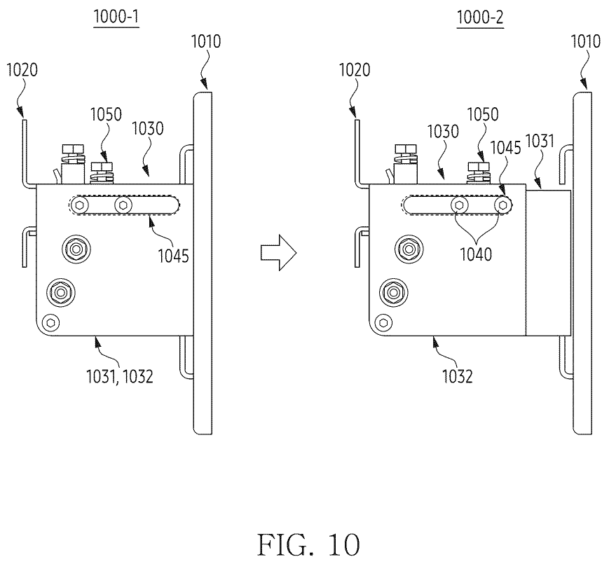

FIG. 10 illustrates an example of a sliding operation of an assembly structure according to an embodiment of the disclosure.

Assembly structures 1000-1 and 1000-2 of FIG. 10 may be understood in the same manner as the assembly structures 600 of FIGS. 6A and 6B.

Referring to FIG. 10, the assembly structure 1000-1 is in a state in which a first portion 1031 and a second portion 1032 of a third bracket 1030 are maximally overlapped and is not slid (hereinafter, referred to as a first state). The assembly structure 1000-1 in the first state may have the minimum distance between a first bracket 1010 and a second bracket 1020. The assembly structure 1000-2 is in a state in which the first portion 1031 and the second portion 1032 of the third bracket 1030 are partially overlapped with an assembly structure 1001-1 and is in a slid state (hereinafter, referred to as a second state). The assembly structure 1000-2 in the second state may have the maximum distance between the first bracket 1010 and the second bracket 1020.

According to an embodiment, in a case of the assembly structure 1000-1, a first fasten member 1040 of the first portion 1031 may be positioned at the end in a first direction and at the center portion of a first slit 1045 within the first slit 1045 of the second portion 1032. The first direction may refer to a direction toward the second bracket 1020 from the first bracket 1010. In addition, in the case of the assembly structure 1000-1, a second fasten member 1050 may be in a fastened state.

According to an embodiment, in a case of the assembly structure 1000-2, the first fasten member 1040 of the first portion 1031 may be positioned at the end in a second direction and at the center portion of the first slit 1045 within the first slit 1045 of the second portion 1032. The second direction may refer to a direction opposite to the first direction and may refer to a direction toward the first bracket 1010 from the second bracket 1020. When the assembly structure 1000-1 is changed to the state of the assembly structure 1000-2, the second fasten member 1050 may be disengaged and may be engaged again after the second portion 1032 moves.

According to an embodiment, the first fasten member 1040 may include a plurality of members for fixing. For example, the first fasten member 1040 of FIG. 10 is illustrated as including two circular screw nails. This is because when there is only one circular screw nail, the assembly structure is rotated in a curved direction rather than in a linear direction. The second portion 1032 may be moved linearly with respect to the first portion 1031 through the two circular screw nails. However, the disclosure is not limited thereto, and the first fasten member 1040 may be a member for fixing one linear shape or a member for fixing one elliptical shape. Alternatively, the first fasten member 1040 may include three or more members.

In FIG. 10, for convenience of description, the assembly structure 1000-1 in the first state and the assembly structure 1000-2 in the second state are shown, but the disclosure is not limited thereto, and the assembly structure of the disclosure may include an assembly structure between the first state and the second state.

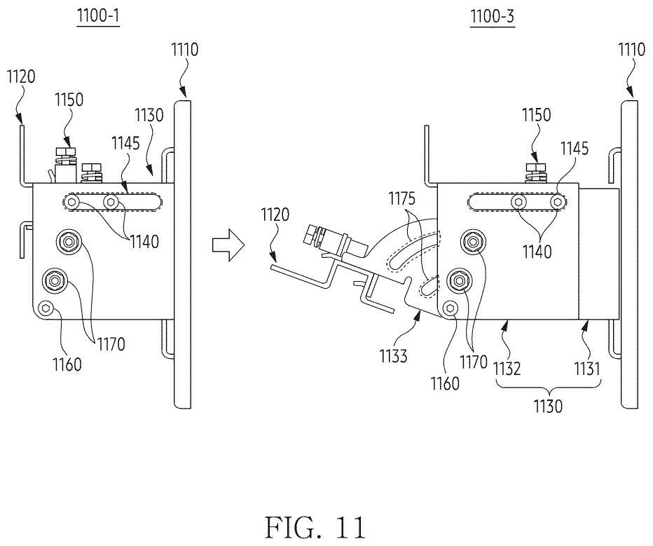

FIG. 11 illustrates an example of a rotating (or tilting) operation of an assembly structure according to an embodiment of the disclosure.

Assembly structures 1100-1 and 1100-3 of FIG. 11 may be understood in the same manner as the assembly structure 600 of FIGS. 6A and 6B.

Referring to FIG. 11, the assembly structure 1100-1 is in a state in which a first portion 1131 and a second portion 1132 of a third bracket 1130 are overlapped by the maximum area and is not slid (hereinafter, referred to as a first state). The assembly structure 1100-1 in the first state may have the minimum distance between a first bracket 1110 and a second bracket 1120. The assembly structure 1100-3 is in a state in which a third portion 1133 is rotated (hereinafter, referred to as a third state) with respect to a rotation axis in a state in which the first portion 1131 and the second portion 1132 of the third bracket 1130 are partially overlapped. For convenience of description, the assembly structure 1100-3 in the third state is illustrated to be in rotated state in the assembly structure 1000-2 of FIG. 10. In addition, the assembly structure 1100-3 may be in a state in which the third portion 1133 is rotated by the maximum rotation angle.

According to an embodiment, in a case of the assembly structure 1100-1, a first fasten member 1140 of the first portion 1131 may be positioned at the end in a first direction and at the center portion of a first slit 1145 within the first slit 1145 of the second portion 1132. The first direction may refer to a direction toward the second bracket 1120 from the first bracket 1110. In addition, in the case of the assembly structure 1100-1, a second fasten member 1150 may be in an engaged state. The assembly structure 1100-1 may be in the same state as the assembly structure 1000-1 of FIG. 10.

According to an embodiment, in a case of the assembly structure 1100-3, the first fasten member 1140 of the first portion 1131 may be positioned at the end in a second direction and at the center portion of the first slit 1145 within the first slit 1145 of the second portion 1132. The second direction may refer to a direction opposite to the first direction and may refer to a direction toward the first bracket 1110 from the second bracket 1120. When the assembly structure 1100-1 is changed to the state of an assembly structure 1100-2, the second fasten member 1150 may be disengaged and may be engaged again after the second portion 1132 moves. The assembly structure 1100-3 may be in a state presupposing the assembly structure 1000-2 of FIG. 10.

According to an embodiment, in the case of the assembly structure 1100-3, the third portion 1133 may be rotated counterclockwise with respect to the third fasten member 1160. Relatively, a sleeve 1170 may be rotated clockwise along a second slit 1175. For example, the assembly structure 1100-3 may refer to a state in which the sleeve 1170 is rotated to the maximum in the clockwise direction within the second slit 1175. When a state is changed from the assembly structure before sliding or sliding to the assembly structure 1100-3, a bolt and a nut of the sleeve 1170 may be released and rotated, and then the bolt and the nut of the sleeve 1170 may be engaged again.

According to an embodiment, the sleeve 1170 may be configured in plural. For example, the sleeve 1170 of FIG. 11 may include two sleeves. However, the disclosure is not limited thereto, and the sleeve 1170 may include one sleeve or three or more sleeves. Stability may vary according to the number of the sleeves 1170. For example, as the number of the sleeves 1170 increases, the stability of the assembly structure during rotation may increase. In addition, as the number of the sleeves 1170 is smaller, a process of the assembly structure is simplified and production cost may be reduced. In addition, as the number of the sleeves 1170 is smaller, the assembly structure may be easily installed even in a narrower space by minimizing a protruding portion during the installation.

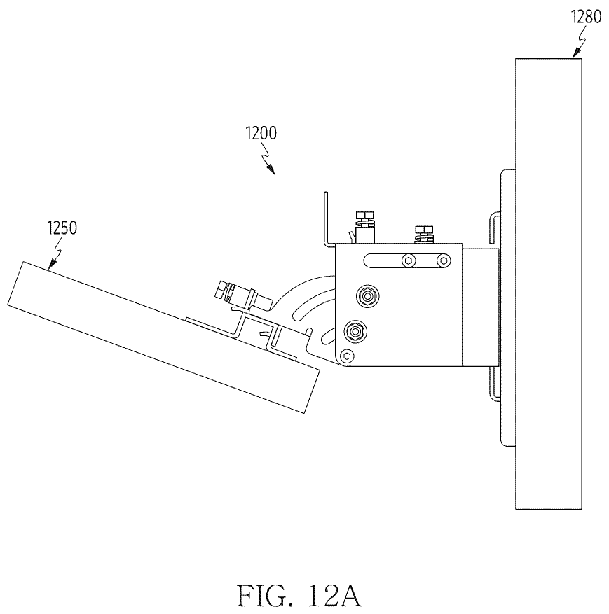

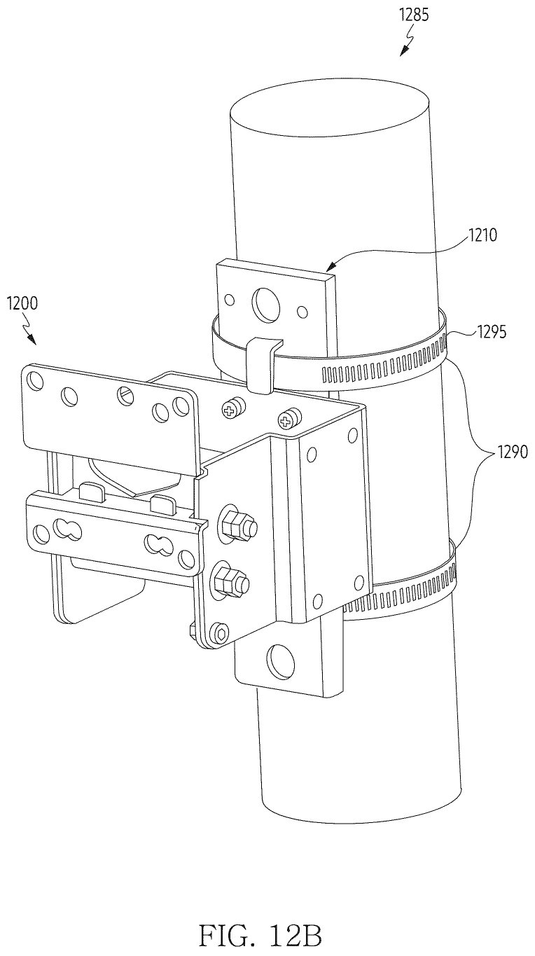

FIG. 12A illustrates an example with respect to a coupling state between an assembly structure and a support structure in an installation environment according to an embodiment of the disclosure. FIG. 12B illustrates another example with respect to a coupling state between an assembly structure and a support structure in an installation environment according to an embodiment of the disclosure.

An assembly structure 1200 of FIGS. 12A and 12B may be understood in the same manner as the assembly structure 600 of FIGS. 6A and 6B. Herein, a support structure in an installation environment may refer to a structure to which communication equipment is installed in order to provide a service to users. For example, the support structure in the installation environment may be a wall, a ceiling, a pole, a tower, and the like.

Referring to FIG. 12A, the support structure in the installation environment may be a wall 1280. According to an embodiment, an assembly structure 1200 may connect communication equipment 1250 and the wall 1280 by being positioned between the communication equipment 1250 and the wall 1280. In a state of being engaged with the communication equipment, the assembly structure 1200 may slide and rotate. The example of FIG. 12A illustrates a state in which the assembly structure 1200 is not slid, and a third portion of the assembly structure 1200 is rotated.

Referring to FIG. 12B, the support structure in the installation environment may be a pole 1285. According to an embodiment, the assembly structure 1200 may connect the communication equipment and the pole 1285 by being positioned between communication equipment (not shown) and the pole 1285. The assembly structure 1200 may further include a steel band 1290 to connect with the pole 1285. For example, a first bracket 1210 of the assembly structure 1200 may be engaged with the pole 1285 through the steel band 1290. According to an embodiment, the first bracket 1210 may further include a coupling member 1295 to be connected with the steel band 1290. The coupling member 1295 may extend from the first bracket 1210 and may be configured in a shape including a space for the steel band 1290 to pass through the first bracket 1210. According to an embodiment, the assembly structure 1200 may further include one or more steel bands 1290. For example, two steel bands 1290 may be included as in the assembly structure 1200 of FIG. 12B. The first bracket 1210 may include two coupling members 1295 corresponding to the two steel bands 1290. However, the disclosure is not limited thereto, and the number and a shape of the steel bands 1290 and the coupling members 1295 may be changed in consideration of a type (e.g., a type, a weight, and the like) of the support structure in the communication equipment, an installation environment, an installation state, and the like.

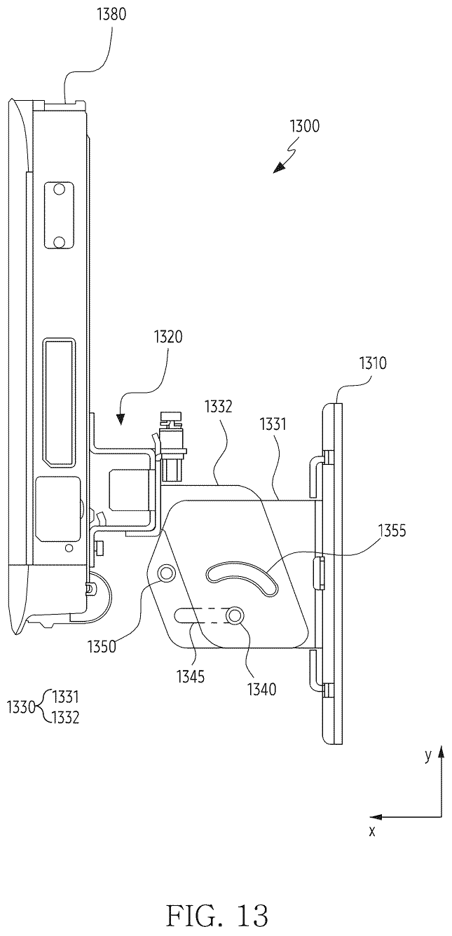

FIG. 13 illustrates another example of an assembly structure according to an embodiment of the disclosure.

An assembly structure 1300 of FIG. 13 may include a structure similar to the assembly structure 600 of FIGS. 6A and 6B. However, unlike the assembly structure 600, the assembly structure 1300 may be a structure in which a structure of a third bracket 1330 is more simplified. Herein, a bracket refers to a device for fixing or coupling a specific object and another object and may be defined as a meaning including the same or similar meaning thereto. For example, the bracket may be referred to as a coupling member. In addition, the assembly structure 1300 may be understood as one bracket in which the brackets are gathered. In other words, the assembly structure 1300 may be referred to as an assembly, a bracket assembly, an assembly for coupling, and the like.

Referring to FIG. 13, according to an embodiment, the assembly structure 1300 may include a first bracket 1310, a second bracket 1320, and a third bracket 1330. The assembly structure 1300 may be engaged with communication equipment 1380 through the second bracket 1320. In addition, the assembly structure 1300 may be engaged with a support structure in an installation environment (not shown) through the first bracket 1310. For example, the first bracket 1310 may be engaged with the support structure in the installation environment through a surface facing a direction opposite to the third bracket 1330. The first bracket 1310 may be engaged with the support structure in the installation environment through a fasten member (e.g., a screw nail, a bolt and a nut, a screw, and the like). In addition, the first bracket 1310 may be engaged with the third bracket 1330 through the fasten member (e.g., the screw nail, the bolt and the nut, the screw, and the like). In addition, the first bracket 1310 may be integrally formed with the third bracket 1330 without being separated from the third bracket 1330.

According to an embodiment, the second bracket 1320 may be a structure for engaging the assembly structure 1300 and the communication equipment 1380. For example, the second bracket 1320 may be engaged with the support structure in the installation environment through a surface facing a direction opposite to the third bracket 1330. The second bracket 1320 may be coupled to the communication equipment 1380 through the fasten member (e.g., the screw nail, the bolt and the nut, the screw, and the like). In addition, the second bracket 1320 may be engaged with the third bracket 1330 through the fasten member.

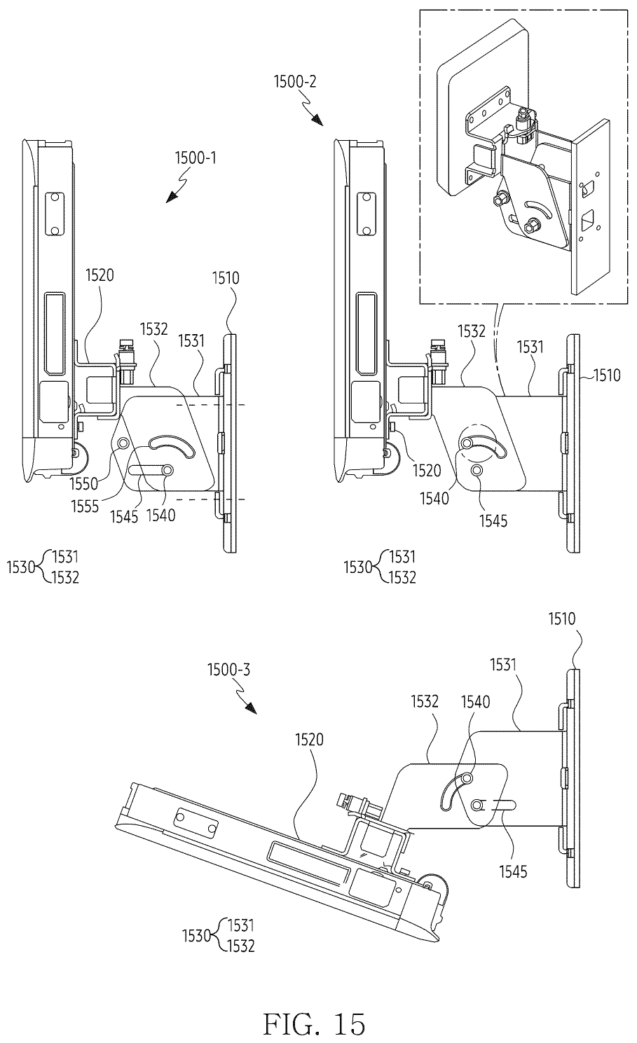

According to an embodiment, the third bracket 1330 may connect the first bracket 1310 and the second bracket 1320 between the first bracket 1310 and the second bracket 1320. Unlike the assembly structure 600 of FIGS. 6A and 6B, the assembly structure 1300 may include the third bracket 1330 having a simplified structure. The third bracket 1330 may include a first portion 1331 and a second portion 1332. The third bracket 1330 may include a first slit 1345 having a straight line shape for a sliding operation, a first sleeve 1340 engaged to the first portion 1331 so as to be positioned within the first slit 1345, a second slit 1355 having a curved shape for rotation operation, and a second sleeve 1350 for fixing a position of the second portion 1332. The first slit 1345 may extend in an x-axis direction. The second slit 1355 may be formed in a curved shape using a virtual line penetrating the center of the first sleeve 1340 as a rotation axis. The details of the sliding and rotating operation of the assembly structure 1300 will be described in detail with reference to FIG. 15.

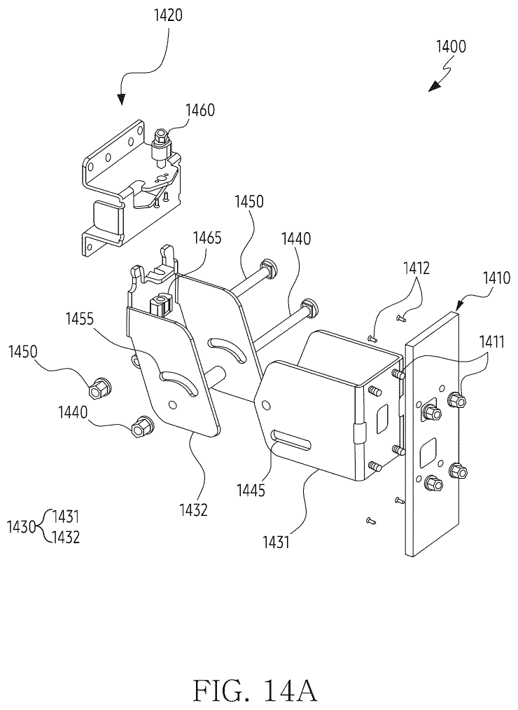

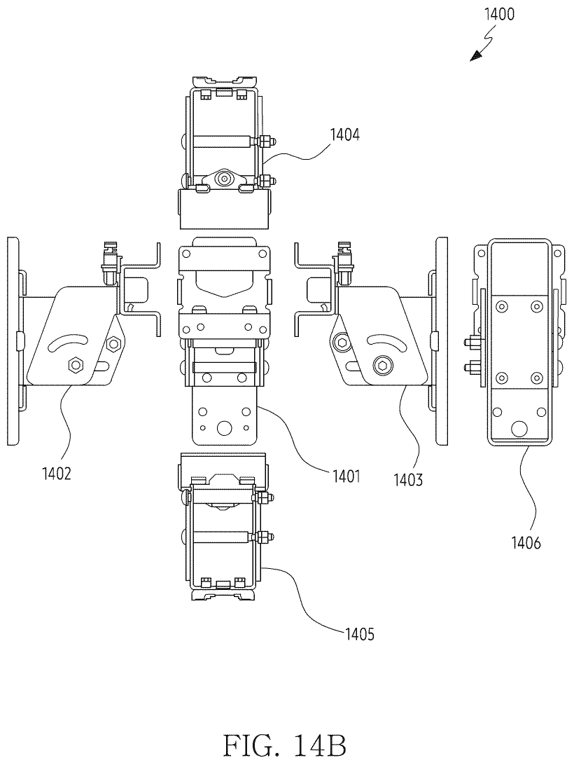

FIG. 14A is an exploded perspective view of another example of an assembly structure according to an embodiment of the disclosure.

In FIG. 14A, an assembly structure 1400 is an exploded view of the assembly structure 1300 of FIG. 13 and may be understood as identical to the assembly structure 1300 of FIG. 13.

Referring to FIG. 14A, the assembly structure 1400 may include a first bracket 1410, a second bracket 1420, and a third bracket 1430. Here, a bracket refers to a device for fixing or coupling a specific object with another object and may be defined as a meaning including a meaning equivalent or similar thereto. For example, the bracket may be referred to as a coupling member. In addition, the assembly structure 1400 may be understood as one bracket in which the brackets are gathered. In other words, the assembly structure 1400 may be referred to as an assembly, a bracket assembly, an assembly for coupling, and the like.

The assembly structure 1400 may be located or disposed between communication equipment (not shown) and a support structure in an installation environment (not shown) and may be engaged with the communication equipment and the support structure in the installation environment, respectively. The first bracket 1410 may be a structure for connecting the assembly structure 1400 to a support structure in an installation environment (e.g., a pole, a ceiling, a wall, a spire, and the like). For example, the first bracket 1410 may be engaged with the support structure in the installation environment through a surface facing a direction opposite to the third bracket 1430. The first bracket 1410 may be engaged with the support structure in the installation environment through a fasten member 1412 (e.g., a screw nail, a bolt and a nut, a screw, and the like). In addition, the first bracket 1410 may be engaged with the third bracket 1430 through a fasten member 1411 (e.g., a screw nail, a bolt and a nut, a screw, and the like). In addition, the first bracket 1410 may be integrally formed with the third bracket 1430 without being separated from the third bracket 1430.

The second bracket 1420 may be a structure for engaging communication equipment with the assembly structure 1400. For example, the second bracket 1420 may be coupled to the support structure in the installation environment through a surface facing a direction opposite to the third bracket 1430. The second bracket 1420 may be coupled to communication equipment through a fasten member (e.g., a screw nail, a bolt and a nut, a screw, and the like). In addition, the second bracket 1420 may be engaged with the third bracket 1430 through a fasten member 1460 and a coupling structure 1465 coupled with the fasten member 1460. For example, the fasten member 1460 and the coupling structure 1465 may be composed of bolts and nuts.

The third bracket 1430 may include a first portion 1431 and a second portion 1432. The first portion 1431 may connect the first bracket 1410 and the third bracket 1430. The first portion 1431 may be engaged with the first bracket 1410 through the fasten member 1411. The first portion 1431 may include a structure for sliding operation of the third bracket 1430. For example, the first portion 1431 may include a first sleeve 1440 for moving along a first slit 1445 of the second portion 1432. The first sleeve 1440 may include a nut for engaging, a sleeve block, and a bolt, extending along the sleeve block, for engaging. The first sleeve 1440 may be engaged with the first portion 1431 to be located within the first slit 1445. As the first sleeve 1440 is moved along the first slit 1445, the assembly structure 1400 may slide. In this case, after the movement is completed along the first slit 1445, the second sleeve 1450 may be engaged with the first portion 1431 or the first portion 1431 and the second portion 1432 so that the second portion 1432 is not rotated.

According to an embodiment, the second portion 1432 may include a second slit 1455 for a rotation operation. The second slit 1455 may be formed in a curved shape while being spaced apart from the first sleeve 1440 by a predetermined distance. The second portion 1432 of the assembly structure 1400 may be rotated around a virtual line penetrating the first sleeve 1440. The second sleeve 1450 may be a structure for fixing the second portion 1432 not to rotate. For example, after the first sleeve 1440 is moved along the first slit 1445 so that the second portion 1432 slides with respect to the first portion 1431, the second sleeve 1450 may be engaged to the first portion 1431 in a state spanning an edge of the second portion 1432 so that the second portion 1432 does not rotate. In addition, in order for the second portion 1432 to be rotated around the first sleeve 1440, the second sleeve 1450 may be released from the engagement. After the engagement of the second sleeve 1450 is released, the second portion 1432 may be rotated, and the second sleeve 1450 may be engaged again to the first portion 1431, by penetrating the second slit 1455 of the second portion 1432 having a curved shape.

As described above, the assembly structure 1400 may include the first bracket 1410 for connecting with the support structure in the installation environment, the second bracket 1420 for engaging the communication equipment, and the third bracket 1430 between the first bracket 1410 and the second bracket 1420. The third bracket 1430 may be configured as structure to perform a sliding operation and a rotating operation of the assembly structure 1400. The assembly structure 1400 may connect the communication equipment and the support structure in the installation environment even when a space for installation is narrow. The communication equipment coupled through the assembly structure 1400 may be spaced apart from the support structure in the installation environment by a predetermined distance, and interference that signals transmitted and received by the communication equipment receive from the support structure in the installation environment may be minimized. In addition, the communication equipment installed by being rotated by a predetermined angle through the assembly structure 1400 may efficiently transmit and receive signals with another external device. In other words, the communication equipment connected to the support structure in the installation environment through the assembly structure 1400 may have improved communication performance.

FIG. 14B is a hexahedral view of another example of an assembly structure according to an embodiment of the disclosure.

An assembly structure 1400 of FIG. 14B may be understood as identical to the assembly structure 1300 of FIG. 13 and the assembly structure 1400 of FIG. 14A. For convenience of description, FIG. 14B illustrates an example in which the assembly structure 1400 is in a state not being moved or rotated (or tilted).

Referring to FIG. 14B, a front view 1401, a left-side view 1402, a right-side view 1403, an upper-side view 1404, a lower side view 1405, and a rear view 1406 of the assembly structure 1400 are illustrated. Referring to the front view 1401, a surface of a second bracket of the assembly structure 1400 may include a plurality of coupling structures (e.g., a hole or a slit) engaged with communication equipment. In addition, although FIG. 14B illustrates that the second bracket of the assembly structure 1400 is coupled to the communication equipment through two contact surfaces, the disclosure is not limited thereto, and the second bracket may be coupled to the communication equipment through one contact surface. In other words, a structure of the second bracket may be changed based on a type of communication equipment coupled to the second bracket, a size of the communication equipment or a method of being coupled to the communication equipment, and the like.

Referring to the left-side view 1402 and the right-side view 1403, the assembly structure 1400 may be configured to be symmetrical to each other with respect to a virtual surface passing through a center of the assembly structure 1400. However, a sleeve for sliding of the assembly structure 1400 includes a bolt and a nut penetrating the assembly structure 1400, and the assembly structure 1400 may be configured in a structure penetrating from left to right or from right to left. That is, a position of the nut or bolt included in the sleeve of the assembly structure 1400 may be reversely changed.

Referring to the upper side view 1404, two sleeves of the assembly structure 1400 may include sleeve blocks penetrating a first portion and a second portion of the third bracket.

Referring to the lower side view 1405, the assembly structure 1400 may include a sleeve penetrating from a left side to a right side, and the sleeve may include a sleeve block extending from a left-side surface to a right-side surface of the assembly structure 1400. The assembly structure 1400 of FIG. 14B may include two sleeves.

Referring to the rear view 1406, the assembly structure 1400 may include a first bracket for connecting with the support structure in the installation environment. In FIG. 14B, the first bracket of the assembly structure 1400 is configured to have the longest shape compared to other parts of the assembly structure 1400 but is merely an example for description. In other words, the first bracket of the assembly structure 1400 may be configured to have a surface shape having a length similar to that of the third bracket. However, when the first bracket is formed to be elongated at the top and the bottom, the first bracket may be more stably engaged with the support structure in the installation environment compared to the short case.

FIG. 15 illustrates an example of a sliding operation and a rotating operation of an assembly structure according to an embodiment of the disclosure.

Assembly structures 1500-1, 1500-2, and 1500-3 of FIG. 15 may be understood as identical to the assembly structure 1300 of FIG. 13.

Referring to FIG. 15, the assembly structure 1500-1 is in a state in which a first portion 1531 and a second portion 1532 of a third bracket 1530 maximally overlap each other and is in a state of non-sliding (hereinafter referred to as a fourth state). In the assembly structure 1500-1 in the fourth state, a distance between the first bracket 1510 and the second bracket 1520 may be minimum. The assembly structure 1500-2 is in a state in which the first portion 1531 and the second portion 1532 of the third bracket 1530 partially overlap each other (hereinafter referred to as a fifth state). In the assembly structure 1500-2 in the fifth state, the distance between the first bracket 1510 and the second bracket 1520 may be maximum. The assembly structure 1500-3 is in a state in which the second portion 1532 is rotated with respect to a first sleeve 1540 in a state that the first portion 1531 and the second portion 1532 of the third bracket 1530 partially overlap (i.e., in the fifth state) (hereinafter referred to as a sixth state). For convenience of description, the assembly structure 1500-3 in the third state is in a state rotated from the assembly structure 1500-2 in the second state. However, the disclosure is not limited thereto, and the assembly structure may be rotated after only a part thereof is slid. In addition, the assembly structure 1500-3 may be in a state in which the second portion 1532 is rotated by a maximum rotation angle. However, the disclosure is not limited thereto, and the assembly structure may be partially rotated.

According to an embodiment, in a case of the assembly structure 1500-1, the first sleeve 1540 of the first portion 1531 may be positioned at an end of a second direction within a first slit 1545 of the first portion 1531. The second direction may mean a direction from the second bracket 1520 toward the first bracket 1510. In this case, a second sleeve 1550 may be engaged to the first portion 1531 in a state spanning an edge of the second portion 1532 to prevent a rotation of the second portion 1532.

According to an embodiment, in a case of the assembly structure 1500-2, the first sleeve 1540 of the first portion 1531 may be positioned at an end of a first direction within the first slit 1545 of the first portion 1531. The first direction may refer to a direction opposite to the second direction, which may refer to a direction from the first bracket 1510 toward the second bracket 1520. When the assembly structure 1500-1 is changed to the state of the assembly structure 1500-2, the second sleeve 1550 is released from the engagement and, after the second portion 1532 moves, may be engaged passing through the first portion 1531 and the second portion 1532 within the second slit 1555. For convenience of description, FIG. 15 illustrates the assembly structure 1500-1 in the fourth state and the assembly structure 1500-2 in the fifth state, but the disclosure is not limited thereto, and the assembly structure of the disclosure may include an assembly structure between the fourth state and the fifth state.

According to an embodiment, in a case of the assembly structure 1500-3, the first sleeve 1540 of the first portion 1531 may be positioned at an end of a first direction within the first slit 1545 of the first portion 1531. The first direction may refer to a direction from the first bracket 1510 toward the second bracket 1520. According to an embodiment, in a case of the assembly structure 1500-3, the second portion 1532 may be rotated counterclockwise with respect to the first sleeve 1540. Relatively, the second sleeve 1550 may be rotated clockwise along the second slit 1555. The assembly structure 1500-3 may refer to a state in which the second sleeve 1550 is rotated to the maximum in the clockwise direction within the second slit 1555. In a case of sliding or changing from the assembly structure before sliding to the assembly structure 1500-3, the engagement of the bolt and the nut of the second sleeve 1550 may be released and rotated. Thereafter, the bolt and the nut of the second sleeve 1550 may be engaged again. For example, the maximum rotatable angle of the communication equipment along the second slit 1555 may be 70°, and in this case a distance between the communication equipment and the support structure in the installation environment may be 150 mm.

Referring to FIGS. 13, 14A, 14B, and 15, the assembly structure may adjust the interval between the communication equipment and the support structure in the installation environment and change an orientation (or position) of the communication equipment, through a plurality of portions included in the third bracket, that is one structure of the assembly structure. Specifically, the assembly structure may adjust the interval between the communication equipment and the support structure in the installation environment through a sliding operation of the first portion and the second portion. For example, the interval between the communication equipment and the support structure in the installation environment may be determined based on interference of signals transmitted and received by the communication equipment. In addition, the assembly structure may change the orientation of the communication equipment through rotation operation (or tilting) of the first portion and the second portion. Through the rotation operation (or tilting), a range of orientation of the communication equipment may be determined by a rotation angle centered on a rotation axis. Here, the rotation angle may be determined according to an opening in a curved shape, of the second slit. The opening in a curved shape of the second slit may be determined and designed according to the coverage of communication equipment. It is assumed that the communication equipment is spaced apart from the ground in a vertical direction, and the transmission/reception unit of the communication equipment is installed in a horizontal direction on the ground. For example, when the coverage of the communication equipment is 45°, users located in the vertical direction of the communication equipment may have difficulty receiving services through the communication equipment. In such an installation environment, it may be necessary to rotate the communication equipment by a predetermined angle in the ground direction. The rotation angle may be required by a minimum of 45°. For example, an angle at which the communication equipment may be maximally rotated along the second slit may be 70°, and in this case, the interval between the communication equipment and the support structure in the installation environment may be 150 mm.

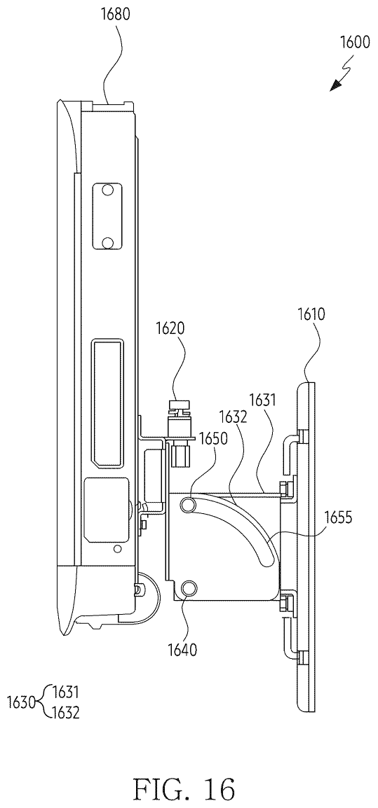

FIG. 16 illustrates another example of an assembly structure according to an embodiment of the disclosure.

An assembly structure 1600 of FIG. 16 may include a structure similar to the assembly structure 600 of FIGS. 6A and 6B or the assembly structure 1300 of FIG. 13. However, unlike the assembly structure 600, the assembly structure 1600 may be a more simplified structure of the third bracket 1630. Here, a bracket refers to a device for fixing or coupling a specific object with another object and may be defined as a meaning equivalent to or similar thereto. For example, the bracket may be referred to as a coupling member. In addition, the assembly structure 1300 may be understood as one bracket in which the brackets are gathered. In other words, the assembly structure 1600 may be referred to as an assembly, a bracket assembly, an assembly for coupling, and the like.

Referring to FIG. 16, according to an embodiment, the assembly structure 1600 may include a first bracket 1610, a second bracket 1620, and a third bracket 1630. The assembly structure 1600 may be engaged with communication equipment 1680 through the second bracket 1620. In addition, the assembly structure 1600 may be engaged with a support structure in an installation environment (not shown) through the first bracket 1610. For example, the assembly structure 1600 may be engaged with the support structure in the installation environment through a surface of the first bracket 1610 facing a direction opposite to the third bracket 1630. The first bracket 1610 may be engaged with the support structure in the installation environment through a fasten member (e.g., a screw nail, a bolt and a nut, a screw, and the like). In addition, the first bracket 1610 may be fastened to the third bracket 1630 through a fasten member (e.g., a screw nail, a bolt and a nut, a screw, and the like). In addition, the first bracket 1610 may be integrally formed with the third bracket 1630 without being separated from the third bracket 1630.

According to an embodiment, the second bracket 1620 may be a structure for engaging the assembly structure 1600 with the communication equipment 1680. For example, the second bracket 1620 may be coupled to the support structure in the installation environment through a surface of the second bracket 1620 facing a direction opposite to the third bracket 1630. The second bracket 1620 may be coupled to the communication equipment 1680 through a fasten member (e.g., a screw nail, a bolt and a nut, a screw, and the like.). In addition, the second bracket 1620 may be coupled to the third bracket 1630 through a fasten member.

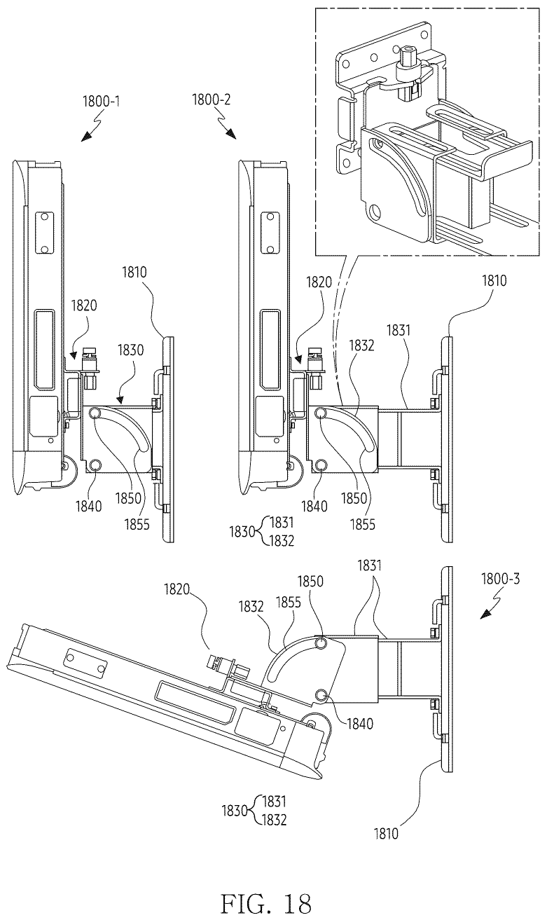

According to an embodiment, the third bracket 1630 may connect the first bracket 1610 and the second bracket 1620 between the first bracket 1610 and the second bracket 1620. Unlike the assembly structure 600 of FIGS. 6A and 6B, the assembly structure 1600 may include the third bracket 1630 having a simplified structure. The third bracket 1630 may include a first portion 1631 and a second portion 1632. The third bracket 1630 may include a rail structure (not shown) of the first portion 1631 for a sliding operation, a first sleeve 1640 engaged by passing through the first portion 1631 and a second portion 1632, a slit 1655 having a curved shape for a rotating operation, and a second sleeve 1650 for fixing a position of the second portion 1632. The slit 1645 may be formed in a curved shape having a virtual line passing through a center of the first sleeve 1640 as a rotation axis. The sliding and rotating operation of the assembly structure 1600 will be described in detail with reference to FIG. 18.

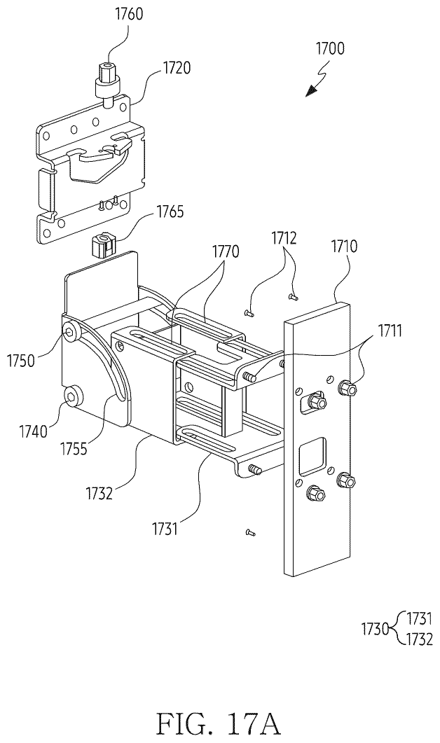

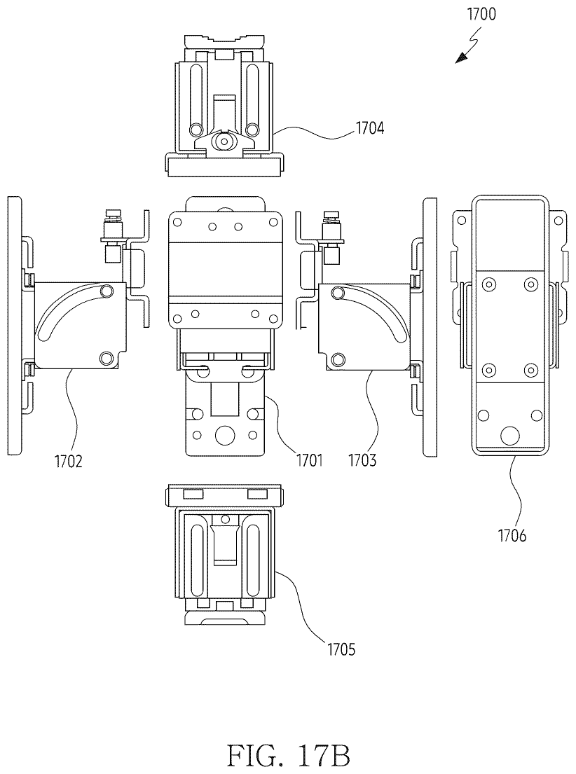

FIG. 17A is an exploded perspective view with respect to another example of an assembly structure according to an embodiment of the disclosure.

In FIG. 17A, an assembly structure 1700 is an exploded view of the assembly structure 1600 of FIG. 16 and may be understood in the same manner as the assembly structure 1600 of FIG. 16.

Referring to FIG. 17A, an assembly structure 1700 may include a first bracket 1710, a second bracket 1720, and a third bracket 1730. Here, a bracket refers to a device for fixing or coupling a specific object with another object and may be defined as a meaning including a meaning equivalent or similar thereto. For example, the bracket may be referred to as a coupling member. In addition, the assembly structure 1700 may be understood as one bracket in which the brackets are gathered. In other words, the assembly structure 1700 may be referred to as an assembly, a bracket assembly, an assembly for coupling, and the like.

The assembly structure 1700 may be located or disposed between the communication equipment (not shown) and the support structure in the installation environment (not shown) and may be engaged to the communication equipment and the support structure in the installation environment, respectively. The first bracket 1710 may be a structure for connecting the assembly structure 1700 to a support structure in an installation environment (e.g., a pole, a ceiling, a wall, a spire, and the like). For example, the first bracket 1710 may be engaged with the support structure in the installation environment through a surface of the first bracket 1710 facing a direction opposite to the third bracket 1730. The first bracket 1710 may be engaged with the support structure in the installation environment through a fasten member 1712 (e.g., a screw nail, a bolt and a nut, a screw, and the like). In addition, the first bracket 1710 may be engaged with the third bracket 1730 through a fasten member 1711 (e.g., a screw nail, a bolt and a nut, a screw, and the like). In addition, the first bracket 1710 may be integrally formed with the third bracket 1730 without being separated from the third bracket 1730.

The second bracket 1720 may be a structure for engaging the assembly structure 1700 with the communication equipment. For example, the second bracket 1720 may be coupled to the support structure in the installation environment through a surface facing in the opposite direction to the third bracket 1730. The second bracket 1720 may be coupled to the communication equipment through a fasten member (e.g., a screw nail, a bolt and a nut, a screw, and the like). In addition, the second bracket 1720 may be engaged with the third bracket 1730 through the fasten member 1760 and an assembly structure 1765 coupled with the fasten member 1760. For example, the fasten member 1760 and the assembly structure 1765 may be composed of bolts and nuts.

The third bracket 1730 may include a first portion 1731 and a second portion 1732. The first portion 1731 may connect the first bracket 1710 and the third bracket 1730. The first portion 1731 may be engaged with the first bracket 1710 through a fasten member 1711. The first portion 1731 may include a structure for sliding operation of the third bracket 1730. For example, the first portion 1731 may include an extendable rail structure 1770. The rail structure 1770 may be separated and extended in two stages for the sliding operation of the third bracket 1730. However, the disclosure is not limited thereto, and the rail structure 1770 may be separated and extended in three or more stages. The rail structure 1770 may be composed in a slit shape. The assembly structure 1700 may include a fasten member (not shown) for fixing a slid state. The rail structure 1770 may be fixed in the slid state through a fasten member (not shown) engaged to penetrate the rail structure 1770 of the first portion 1731.

The assembly structure 1700 may include a first sleeve 1740 for connecting the first portion 1731 and the second portion 1732. The first sleeve 1740 may be engaged to penetrate a portion of the first portion 1731 and the second portion 1732. Here, the portion of the first portion 1731 may refer to one end of the first portion 1731 extended by the rail structure 1770. The first sleeve 1740 may include a nut for engaging, a sleeve block, and a bolt for engaging extending along the sleeve block.

According to an embodiment, the second portion 1732 may include a slit 1755 for a rotation operation. The slit 1755 may be formed in a curved shape while being spaced apart from the first sleeve 1740 by a predetermined distance. The second portion 1732 of the assembly structure 1700 may be rotated around a virtual line penetrating the first sleeve 1740. The second sleeve 1750 may be a structure for fixing the second portion 1732 not to rotate. In addition, in order for the second portion 1732 to be rotated around the first sleeve 1740, the second sleeve 1750 may be released from the engagement. After the second sleeve 1750 is released from the engagement, the second portion 1732 may be rotated, and the second sleeve 1750 may be engaged again with the first portion 1731, penetrating the slit 1755 in a curved shape of the second portion 1732.

As described above, the assembly structure 1700 may include the first bracket 1710 for connecting with the support structure in the installation environment, the second bracket 1720 for engaging the communication equipment, and the third bracket 1730 between the first bracket 1710 and the second bracket 1720. The third bracket 1730 may be configured as a structure to perform a sliding operation and a rotating operation of the assembly structure 1700. The assembly structure 1700 may connect the communication equipment and the support structure in the installation environment even when the space for installation is narrow. The communication equipment coupled through the assembly structure 1700 may be spaced apart from the support structure in the installation environment by a predetermined distance, and interference that signals transmitted and received by communication equipment receive from the support structure in the installation environment may be minimized. In addition, the communication equipment installed by being rotated by a predetermined angle through the assembly structure 1700 may efficiently transmit and receive signals with other external devices. In other words, the communication equipment connected to the support structure in the installation environment through the assembly structure 1700 may have improved communication performance.

FIG. 17B is a hexagonal view with respect to another example of an assembly structure according to an embodiment of the disclosure.

The assembly structure 1700 of FIG. 17B may be understood as identical to the assembly structure 1300 of FIG. 13 and the assembly structure 1700 of FIG. 17A. For convenience of description, FIG. 17B illustrates an example of a state in which the assembly structure 1700 is not moved or rotated (or tilted).

Referring to FIG. 17B, a front view 1701, a left-side view 1702, a right-side view 1703, an upper side view 1704, a lower side view 1705, and a rear side view 1706 of the assembly structure 1700 are illustrated. Referring to the front view 1701, a surface of a second bracket of the assembly structure 1700 may include a plurality of assembly structures (e.g., a hole or a slit) engaged to the communication equipment. In addition, although FIG. 17B illustrates that the second bracket of the assembly structure 1700 is coupled to the communication equipment through two contact surfaces, the disclosure is not limited thereto, and the second bracket may be coupled to the communication equipment through one contact surface. In other words, a structure of the second bracket may be changed based on a type of communication equipment to be coupled to the second bracket, a size of the communication equipment, a method of being coupled to the communication equipment, and the like.

Referring to the left-side view 1702 and the right-side view 1703, the assembly structure 1700 may be configured to be symmetrical to each other with respect to a virtual surface passing through a center of the assembly structure 1700. However, since a sleeve for sliding of the assembly structure 1700 includes a bolt and a nut penetrating the assembly structure 1700, the assembly structure 1700 may be configured as a structure to penetrate from left to right or from right to left. That is, a position of the nut or bolt included in the sleeve of the assembly structure 1700 may be reversely changed.

Referring to the upper side view 1704 and the lower side view 1705, the assembly structure 1700 may include a rail structure for a sliding operation. The rail structure may be included in a first portion of the third bracket, and the first portion may extend to a plurality of ends by the rail structure. In order to fix the rail structure slid, the assembly structure 1700 may include a fasten member engaged to penetrate the rail structure.

Referring to the rear side view 1706, the assembly structure 1700 may include a first bracket for connection with the support structure in the installation environment. In FIG. 17B, the first bracket of the assembly structure 1700 is configured to have the longest shape compared to other parts of the assembly structure 1700, but this is merely an example for description. In other words, the first bracket of the assembly structure 1700 may be configured to have a surface shape having a length similar to that of the third bracket. However, when the first bracket is formed long at the top and the bottom, it may be more stably engaged with the support structure in the installation environment compared to the short case.

FIG. 18 illustrates an example with respect to a sliding operation and a rotating operation of an assembly structure according to an embodiment of the disclosure.

Assembly structures 1800-1, 1800-2, and 1800-3 of FIG. 18 may be understood as identical to the assembly structure 1600 of FIG. 16.

Referring to FIG. 18, the assembly structure 1800-1 is in a non-slid state (hereinafter, referred to as a seventh state) as a state in which a rail structure of a first portion 1831 of the third bracket 1830 is not extended. In the assembly structure 1800-1 in the seventh state, a distance between the first bracket 1810 and the second bracket 1820 may be minimum. The assembly structure 1800-2 is in a slid state (hereinafter, referred to as an eighth state) in a state in which the rail structure of the first portion 1831 of the third bracket 1830 is extended. In the assembly structure 1800-2 in the eighth state, the distance between the first bracket 1810 and the second bracket 1820 may be maximum. The assembly structure 1800-3 is in a state in which the second portion 1832 is rotated with respect to the first sleeve 1840 in a state that the rail structure of the first portion 1831 of the third bracket 1830 is extended (i.e., in the eighth state) (hereinafter, referred to as a ninth state). For convenience of description, the assembly structure 1800-3 in the third state is rotated from the assembly structure 1800-2 in the eighth state. However, the disclosure is not limited thereto, and the assembly structure may be rotated after only a part thereof is slid. In addition, the assembly structure 1800-3 may be in a state in which the second portion 1832 is rotated by a maximum rotation angle. However, the disclosure is not limited thereto, and the assembly structure may be partially rotated.

According to an embodiment, in a case of the assembly structure 1800-1, the first sleeve 1840 of the first portion 1831 may be engaged with the first portion 1831 and the second portion 1832 in a region where an edge of the first portion 1831 and another edge extending from the edge are in contact. The second sleeve 1850 may be engaged by penetrating the first portion 1831 and the second portion 1832 within the curved slit 1855 to prevent rotation of the second portion 1832.

According to an embodiment, in a case of the assembly structure 1800-2, the rail structure of the first portion 1831 may extend in the first direction. The first direction may refer to a direction from the first bracket 1810 toward the second bracket 1820. When the assembly structure 1800-1 is changed to the state of the assembly structure 1800-2, the fasten member for the rail structure may be released from the engagement. After the rail structure is extended, the fasten member may be engaged again to penetrate the extended rail structure. In FIG. 18, for convenience of description, the assembly structure 1800-1 in the seventh state and the assembly structure 1800-2 in the eighth state are illustrated, but the disclosure is not limited thereto, and the assembly structure of the disclosure may include an assembly structure between the seventh state and the eighth state.

According to an embodiment, in a case of the assembly structure 1800-3, the second portion 1832 may be rotated counterclockwise around the first sleeve 1840. Relatively, the second sleeve 1850 may be rotated clockwise along the curved slit 1855. The assembly structure 1800-3 may mean a state in which the second sleeve 1850 is rotated to the maximum in the clockwise direction within the curved slit 1855. In case of sliding or changing from the assembly structure before sliding to the assembly structure 1800-3, the engagement of the bolts and nuts of the second sleeve 1850 may be released and rotated, and then the bolts and nuts of the second sleeve 1850 may be engaged again. For example, an angle at which the communication equipment is maximally rotatable along the curved slit 1855 may be 70°, in which case the distance between the communication equipment and the support structure in the installation environment may be 150 mm.

Referring to FIGS. 17A, 17B, and 18, the assembly structure may adjust an interval between the communication equipment and the support structure in the installation environment and change an orientation (or position) of the communication equipment, through a plurality of portions included in the third bracket, which is one structure of the assembly structure. Specifically, the assembly structure may adjust the interval between the communication equipment and the support structure in the installation environment through a sliding operation by the rail structure of the first portion. For example, the interval between the communication equipment and the support structure in the installation environment may be determined based on interference of signals transmitted and received by the communication equipment. In addition, the assembly structure may change the orientation of the communication equipment through rotation operation (or tilting) of the first portion and the second portion. Through the rotation operation (or tilting), a range of orientation of the communication equipment may be determined by a rotation angle centered on a rotation axis. Here, the rotation angle may be determined according to an opening in a curved shape of the second slit. The opening in a curved shape of the second slit may be determined and designed according to coverage of the communication equipment. It is assumed that the communication equipment is spaced apart from the ground in a vertical direction, and the transmission/reception unit of the communication equipment is installed in a horizontal direction on the ground. For example, when the coverage of the communication equipment is 45°, users located in the vertical direction of the communication equipment may have difficulty receiving services through the communication equipment. In such an installation environment, it may be necessary to rotate the communication equipment by a certain angle in the ground direction. The rotation angle may be required by a minimum of 45°. For example, an angle at which the communication equipment may be maximally rotated along the second slit may be 70°, and in this case, an interval between the communication equipment and the support structure in the installation environment may be 150 mm.

Referring to FIGS. 6A, 6B, 7 to 11, 12A, 12B, 13, 14A, 14B, 15, 16, 17A, 17B, and 18, an assembly structure capable of adjusting the position of communication equipment according to embodiments of the disclosure may be used in various situations compared to an existing fixed assembly structure. The existing fixed assembly structure is fixed to a size determined during a production process, but the assembly structure according to embodiments of the disclosure may adjust the separation distance between the communication equipment and the support structure in the installation environment through a sliding operation. Therefore, the assembly structure according to embodiments of the disclosure may be flexibly installed by adjusting the separation distance based on installation conditions in consideration of support structures in installation environments (e.g., a wall, a ceiling, and a pole), communication equipment, and the like. In addition, the assembly structure according to embodiments of the disclosure may be applied variously only with a simplified structure, thereby minimizing production costs and processes. Additionally, the separation distance may be adjusted to minimize a size of the assembly structure according to an embodiment of the disclosure, and packaging and delivery of the assembly structure may be made at low cost and high efficiency compared to the existing assembly structure. In addition, by using the assembly structure according to embodiments of the disclosure, communication equipment may adjust the separation distance from the support structure in the installation environment, and communication equipment may minimize interference with the support structure in the installation environment.

In addition, the assembly structure according to the embodiments of the disclosure may efficiently minimize interference compared to the existing assembly structure including the tilting function. For example, the existing assembly structure including the tilting function may have a fixed separation distance between communication equipment and the support structure in the installation environment or may require a minimum separation distance for tilting. That is, the existing assembly structure including the tilting function may incur an unnecessary protruding section due to structural limitations. In contrast, the assembly structure according to the embodiments of the disclosure may adjust the separation distance through sliding operations and may only be separated by the separation distance that may be required to minimize interference in performing the tilting function, thereby efficiently minimizing interference. In addition, the existing assembly structure including the tilting function may perform the tilting function through a plurality of components, but the slidable assembly structure according to the embodiments of the disclosure may perform the tilting function by one structure.

In addition, the assembly structure according to embodiments of the disclosure is highly space-utilized and may be installed at a low cost by being combined with the support structure in the installation environment through an additional coupling member. For example, the existing fixed assembly structure or the assembly structure including the tilting function may connect communication equipment and a support structure in an installation environment (e.g., a wall, a ceiling, and a pole) by a plurality of components. In contrast, the assembly structure according to embodiments of the disclosure may connect communication equipment and the support structure in the installation environment through one structure, thereby minimizing space usage.

As described above, the assembly may include a first bracket connected to the support structure in the installation environment. The assembly may include a second bracket for mounting communication equipment. The assembly may include a third bracket, between the first bracket and the second bracket, engaged with each of the first bracket and the second bracket, for changing an orientation of the second bracket and changing a position of the second bracket. The third bracket may include a first portion engaged with the first bracket and including at least one first fasten member. The third bracket may include a second portion including a first slit, arranged with respect to the at least one first fasten member, disposed toward a first direction and at least one sleeve. The second portion may be moved with respect to the first portion according to the at least one first fasten member moved toward the first direction in the first slit or the at least one first fasten member moved toward a second direction opposite to the first direction in the first slit. The third bracket may include a third portion, rotatably connected to the second portion based on a rotation axis, including a second slit formed as a curve, engaged with the second bracket, and arranged with respect to the at least one sleeve. The third portion may be rotated with respect to the first portion and the second portion according to the at least one sleeve moved toward the first rotation direction in the second slit or the at least one sleeve moved in the second rotation direction opposite to the first rotation direction within the second slit.

According to an embodiment, the first portion may include a second fasten member. The first portion may be engaged to the second portion through the second fasten member.

According to an embodiment, the at least one first fasten member may include two sets of bolts and nuts.

According to an embodiment, the second portion may include a third fasten member. The second portion may be engaged with the third portion through the third fasten member. The rotation axis may be a virtual line vertically penetrating the third fasten member.

According to an embodiment, the at least one sleeve may include a first sleeve and a second sleeve. The second slit may include a slit corresponding to the first sleeve and a slit corresponding to the second sleeve.

According to an embodiment, the rotation axis may be positioned in a region where a periphery adjacent to the second bracket of the third portion and another periphery extending from the periphery are in contact. The second slit formed as a curve may be formed based on the rotation axis.

According to an embodiment, the second slit may be formed in a curved shape with a rotation angle of 70° based on the rotation axis.

According to an embodiment, a range of movement toward the first direction or the second direction of the third bracket may be determined in accordance with a length in the first direction of the first slit.

According to an embodiment, the assembly may further comprise a steel band for coupling the first bracket and the support structure in the installation environment. The first bracket may further include a coupling member extended from the first bracket for engaging with the steel band.

As described above, a base station may include communication equipment. The base station may include a pole. The base station may include an assembly between the pole and the communication equipment. The assembly may include a first bracket configured to couple to a support structure in an installation environment. The assembly may include a second bracket configured to couple to communication equipment. The assembly may include a third bracket, engaged with the first bracket and the second bracket, between the first bracket and the second bracket, for changing the orientation of the second bracket and changing the position of the second bracket. The third bracket may include a first portion engaged with the first bracket and including at least one first fasten member. The third bracket may include a second portion including a first slit, arranged with respect to the at least one fasten member and disposed along a first direction, and at least one sleeve. The second portion may be moved with respect to the first portion in accordance with the at least one first fasten member moved toward the first direction in the first slit or the at least one first fasten member moved toward a second direction opposite to the first direction in the first slit. The third bracket may include a third portion, rotatably connected to the second portion based on a rotation axis, including a second slit formed as a curve, engaged with the second bracket, and arranged with respect to the at least one sleeve. The third portion may be rotated with respect to the first portion and the second portion in accordance with the at least one sleeve moved toward a first rotation direction in the second slit or the at least one sleeve moved toward a second rotation direction opposite to the first rotation direction in the second slit.

According to an embodiment, the first portion may include a second fasten member. The first portion may be engaged with the second portion through the second fasten member.

According to an embodiment, the at least one first fasten member may include two sets of bolts and nuts.

According to an embodiment, the second portion may include a third fasten member. The second portion may be engaged with the third portion through the third fasten member. The rotation axis may be a virtual line vertically penetrating the third fasten member.

According to an embodiment, the at least one sleeve may include a first sleeve and a second sleeve. The second slit may include a slit corresponding to the first sleeve and a slit corresponding to the second sleeve.

According to an embodiment, the rotation axis may be located in a region where a periphery adjacent to the second bracket of the third portion and another periphery extending from the periphery are in contact. The second slit may be formed as the curve based on the rotation axis.

According to an embodiment, the second slit may be formed in a curved shape with a rotation angle of 70° based on the rotation axis.

According to an embodiment, a range of movement toward the first direction or the second direction of the third bracket may be determined in accordance with a length of the first slit.

According to an embodiment, the assembly may further comprise a steel band for coupling the first bracket and the support structure. The first bracket may further include a coupling member extended from the first bracket for engaging with the steel band.

Methods according to embodiments described in claims or specifications of the disclosure may be implemented as a form of hardware, software, or a combination of hardware and software.

In case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An assembly comprising:
a first bracket configured to couple to a support structure in an installation environment;
a second bracket configured to couple to communication equipment; and
a third bracket, engaged with the first bracket and the second bracket between the first bracket and the second bracket, for changing an orientation of the second bracket and changing a position of the second bracket,
wherein the third bracket includes:
a first portion, engaged with the first bracket, including at least one first fasten member,
a second portion including a first slit, arranged with respect to the at least one fasten member and disposed along a first direction, and at least one sleeve, wherein the second portion is moved with respect to the first portion in accordance with the at least one first fasten member moved toward the first direction in the first slit or the at least one first fasten member moved toward a second direction opposite to the first direction in the first slit, and
a third portion, rotatably connected to the second portion based on a rotation axis, including a second slit formed as a curve, engaged with the second bracket, and arranged with respect to the at least one sleeve, and
wherein the third portion is rotated with respect to the first portion and the second portion in accordance with the at least one sleeve moved toward a first rotation direction in the second slit or the at least one sleeve moved toward a second rotation direction opposite to the first rotation direction in the second slit.

2. The assembly of claim 1,
wherein the first portion includes a second fasten member, and
wherein the first portion is engaged with the second portion via the second fasten member.

3. The assembly of claim 1, wherein the at least one first fasten member includes two sets of a bolt and a nut.

4. The assembly of claim 1,
wherein the second portion includes a third fasten member,
wherein the second portion is engaged with the third portion via the third fasten member, and
wherein the rotation axis is a virtual line vertically penetrating the third fasten member.

5. The assembly of claim 1, wherein each of the at least one sleeve includes a nut, a sleeve block, and a bolt extended along the sleeve block.

6. The assembly of claim 5,
wherein the at least one sleeve includes a first sleeve and a second sleeve, and
wherein the second slit includes a slit corresponding to the first sleeve and a slit corresponding to the second sleeve.

7. The assembly of claim 1,
wherein the rotation axis is positioned in a region where a periphery adjacent to the second bracket of the third portion is in contact with another periphery extended from the periphery, and
wherein the second slit is formed as the curve based on the rotation axis.

8. The assembly of claim 1, wherein a range of movement toward the first direction or the second direction of the third bracket is determined in accordance with a length of the first slit.

9. The assembly of claim 1,
wherein the assembly further comprises a steel band for coupling the first bracket and the support structure, and
wherein the first bracket further includes a coupling member extended from the first bracket for engaging with the steel band.

10. The assembly of claim 1, wherein the support structure in the installation environment to which the first bracket is configured to couple is one of a pole, a ceiling, a wall, or a tower.

11. A base station comprising:
communication equipment;
a support structure; and
an assembly disposed between the support structure and the communication equipment,
wherein the assembly comprises:
a first bracket coupled to the support structure, a second bracket coupled to the communication equipment, and a third bracket engaged with the first bracket and the second bracket between the first bracket and the second bracket, for changing an orientation of the second bracket and changing a position of the second bracket,
wherein the third bracket includes:
a first portion, engaged with the first bracket, including at least one first fasten member,
a second portion including a first slit, arranged with respect to the at least one fasten member and disposed along a first direction, and at least one sleeve, wherein the second portion is moved with respect to the first portion in accordance with the at least one first fasten member moved toward the first direction in the first slit or the at least one first fasten member moved toward a second direction opposite to the first direction in the first slit, and
a third portion, rotatably connected to the second portion based on a rotation axis, including a second slit formed as a curve, engaged with the second bracket, and arranged with respect to the at least one sleeve, and
wherein the third portion is rotated with respect to the first portion and the second portion in accordance with the at least one sleeve moved toward a first rotation direction in the second slit or the at least one sleeve moved toward a second rotation direction opposite to the first rotation direction in the second slit.

12. The base station of claim 11,
wherein the first portion includes a second fasten member, and
wherein the first portion is engaged with the second portion via the second fasten member.

13. The base station of claim 11, wherein the at least one first fasten member includes two sets of a bolt and a nut.

14. The base station of claim 11,
wherein the second portion includes a third fasten member,
wherein the second portion is engaged with the third portion via the third fasten member, and
wherein the rotation axis is a virtual line vertically penetrating the third fasten member.

15. The base station of claim 11, wherein each of the at least one sleeve includes a nut, a sleeve block, and a bolt extended along the sleeve block.

16. The base station of claim 15,
wherein the at least one sleeve includes a first sleeve and a second sleeve, and
wherein the second slit includes a slit corresponding to the first sleeve and a slit corresponding to the second sleeve.

17. The base station of claim 11,
wherein the rotation axis is positioned in a region where a periphery adjacent to the second bracket of the third portion is in contact with another periphery extended from the periphery, and
wherein the second slit is formed as the curve based on the rotation axis.

18. The base station of claim 11, wherein a range of movement toward the first direction or the second direction of the third bracket is determined in accordance with a length of the first slit.

19. The base station of claim 11,
wherein the assembly further comprises a steel band for coupling the first bracket and the support structure, and
wherein the first bracket further includes a coupling member extended from the first bracket for engaging with the steel band.

20. The base station of claim 11, wherein the support structure is one of a pole, a ceiling, a wall, or a tower.
